(19) United States
(12) Patent Application Publication
(10) Pub. No.: US 2026/0280625 A1
(43) Pub. Date: Sep. 17, 2026

(54) METHOD AND APPARATUS FOR PERFORMING MULTIPLE-INPUT MULTIPLE-OUTPUT ANTENNA-BASED UPLINK TRANSMISSION AND RECEPTION IN WIRELESS COMMUNICATION SYSTEM

(71) Applicant: SAMSUNG ELECTRONICS CO., LTD., Suwon-si (KR)

(72) Inventors: Geonwoong JUNG, Suwon-si (KR); Seunghyun LEE, Suwon-si (KR)

(21) Appl. No.: 19/568,602

(22) Filed: Mar. 16, 2026

(30) Foreign Application Priority Data
Mar. 14, 2025 (KR) 10-2025-0033086

(51) Int. Cl. H04B 7/0456; H04L 27/26

(52) U.S. Cl. CPC H04B 7/0456; H04L 27/261

(57) ABSTRACT

The present disclosure relates to a 5G communication system or a 6G communication system for supporting higher data rates beyond a 4G communication system such as long term evolution (LTE). According to an embodiment of the disclosure, a method performed by a base station in a wireless communication system is provided, the method including transmitting, to a terminal, codebook configuration information associated with a second codebook, the second codebook is applicable to a first codebook, and sounding reference signal (SRS) configuration information for configuring an SRS transmission resource; receiving, from the terminal, an SRS on the SRS transmission resource configured based on the SRS configuration information; based on the received SRS, determining a transmitted precoding matrix indicator (TPMI) based on the first codebook and a precoding matrix control parameter based on the second codebook; and transmitting, to the terminal, information associated with the precoding matrix control parameter and the TPMI.

### CROSS-REFERENCE TO RELATED APPLICATION

This application is based on and claims priority under 35 U.S.C. § 119 to Korean Patent Application No. 10-2025-0033086, filed on Mar. 14, 2025, in the Korean Intellectual Property Office, the disclosure of which is herein incorporated by reference in its entirety.

### BACKGROUND

### 1. Field

The disclosure relates to a wireless communication system or a mobile communication system. More specifically, the disclosure relates to a method for codebook-based uplink data transmission and reception in a multiple-input multiple-output (MIMO) system.

### 2. Description of Related Art

Considering the development of wireless communication from generation to generation, the technologies have been developed mainly for services targeting humans, such as voice calls, multimedia services, and data services. Following the commercialization of 5G (5th-generation) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G (6th-generation) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bps and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz band (for example, 95 GHz to 3 THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, high-altitude platform stations (HAPS), and the like in an integrated manner; an improved network structure for supporting mobile base stations and the like and enabling network operation optimization and automation and the like; a dynamic spectrum sharing technology via collision avoidance based on a prediction of spectrum usage; an use of artificial intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as mobile edge computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

### SUMMARY

An aspect of the disclosure is to improve the performance of uplink multiple-input multiple-output (MIMO) transmission.

To address the above-described problems, an embodiment of the disclosure provides a method performed by a base station in a wireless communication system, the method including transmitting, to a terminal, codebook configuration information regarding a second codebook applicable to a first codebook, and sounding reference signal (SRS) configuration information for configuring an SRS transmission resource, receiving, from the terminal, an SRS through the SRS transmission resource configured based on the SRS configuration information, determining, based on the received SRS, a transmitted precoding matrix indicator (TPMI) based on the first codebook and a precoding matrix control parameter based on the second codebook, and transmitting, to the terminal, information regarding the determined precoding matrix control parameter and the determined TPMI.

Another embodiment of the disclosure provides a method performed by a terminal in a wireless communication system, the method including receiving, from a base station, codebook configuration information regarding a second codebook applicable to a first codebook, and sound reference signal (SRS) configuration information for configuring an SRS transmission resource, transmitting, to the base station, an SRS through the SRS transmission resource configured based on the SRS configuration information, receiving, from the base station, information regarding a transmitted precoding matrix indicator (TPMI) based on the first codebook and information regarding a precoding matrix control parameter based on the second codebook, and transmitting uplink data to the base station, based on the received TPMI and the received information regarding the precoding matrix control parameter.

Yet another embodiment of the disclosure provides a base station in a wireless communication system, the base station including a memory, a transceiver, and at least one processor configured to perform control to transmit, to a terminal through the transceiver, codebook configuration information regarding a second codebook applicable to a first codebook, and sounding reference signal (SRS) configuration information for configuring an SRS transmission resource, receive, from the terminal through the transceiver, an SRS through the SRS transmission resource configured based on the SRS configuration information, determine, based on the received SRS, a transmitted precoding matrix indicator (TPMI) based on the first codebook and a precoding matrix control parameter based on the second codebook, and transmit, to the terminal through the transceiver, information on the determined TPMI and information on the determined precoding matrix control parameter.

Still yet another embodiment of the disclosure provides a terminal in a wireless communication system, the terminal including a memory, a transceiver, and at least one processor configured to perform control to receive, from a base station through the transceiver, codebook configuration information regarding a second codebook applicable to a first codebook and sounding reference signal (SRS) configuration information for configuring an SRS transmission resource, transmit, to the base station through the transceiver, an SRS through the SRS transmission resource configured based on the SRS configuration information, receive, from the base station through the transceiver, information regarding a transmitted precoding matrix indicator (TPMI) based on the first codebook and information regarding a precoding matrix control parameter based on the second codebook, and transmit uplink data to the base station through the transceiver, based on the received TPMI and the received information regarding the precoding matrix control parameter.

According to an embodiment of the disclosure, it is possible to improve the performance of uplink MIMO transmission by enabling the application of an uplink transmission beam that is not limited to a preconfigured TPMI beam direction, based on codebook configuration information.

Advantageous effects obtainable from the disclosure may not be limited to the above-mentioned effects, and other effects which are not mentioned herein may be clearly understood from the following description by those skilled in the art to which the disclosure pertains.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a an example of codebook-based uplink transmission according to an embodiment of the present disclosure;

FIG. 2A illustrates an example of uplink MU-MIMO transmission and reception for two UE according to an embodiment of the present disclosure s;

FIG. 2B illustrates an example of uplink MU-MIMO transmission and reception for four UEs according to an embodiment of the present disclosure;

FIG. 3A illustrates an example of relationships among \tilde{h}₁, \tilde{h}₂, f₁ and u_{1,2} according to an embodiment of the present disclosure;

FIG. 3B illustrates an example of relationships among \tilde{h}₁, \tilde{h}₂, f₁, and u_{1,2} in a case where an uplink MIMO transmission and reception method apply according to an embodiment of the present disclosure;

FIG. 4 illustrates a flowchart of an uplink MIMO transmission and reception method according to an embodiment of the present disclosure;

FIG. 5 illustrates a flowchart of an uplink MIMO transmission and reception method according to an embodiment of the present disclosure;

FIG. 6 illustrates a flowchart of an uplink MIMO transmission and reception method according to an embodiment of the present disclosure;

FIG. 7 illustrates a flowchart of an uplink MIMO transmission and reception method according to an embodiment of the present disclosure;

FIG. 8 illustrates a flowchart of an uplink MIMO transmission and reception method according to an embodiment of the present disclosure;

FIG. 9 illustrates a flowchart of an uplink MIMO transmission and reception method according to an embodiment of the present disclosure;

FIG. 10 illustrates a flowchart of an uplink MIMO transmission and reception method according to an embodiment of the present disclosure; and

FIG. 11 illustrates a flowchart of an uplink MIMO transmission and reception method according to an embodiment of the present disclosure.

FIG. 12 illustrates a terminal or user equipment according to an embodiment of the present disclosure;

FIG. 13 illustrates a base station according to an embodiment of the present disclosure; and

FIG. 14 illustrates a network entity for performing a network function according to an embodiment of the present disclosure.

### DETAILED DESCRIPTION

Hereinafter, embodiments of the disclosure will be described in detail with reference to the accompanying drawings.

In describing the embodiments, while numerous details are set forth for the purpose of illustration, it is understood that some aspects of the disclosure may be practiced with less than all of these details. Numerous variations and alternatives to the details provided herein are possible and are considered within the scope of the disclosure. In some instances, descriptions related to technical contents well-known in the art may be omitted so as to not obscure an understanding of the disclosure, and such omitted descriptions are understood to be within the scope of the disclosure.

For the same reason, in the accompanying drawings, some elements may be exaggerated, omitted, or schematically illustrated. Further, the size of each element does not completely reflect the actual size. In the drawings, identical or corresponding elements are provided with identical reference numerals or different reference numerals.

The advantages and features of the disclosure and ways to achieve them will be apparent by making reference to embodiments as described herein in detail in conjunction with the accompanying drawings. However, the disclosure is not limited to the embodiments set forth herein, but may be implemented in various different forms. Other features, aspects, and advantages of the subject matter described herein will become apparent from the disclosure. The following embodiments are merely examples to aid in an understanding of the disclosure and should not be construed to narrow the scope or spirit of the subject matter described herein in any way, but on the contrary, the disclosure covers all modifications, equivalents and alternatives falling within the spirit and scope of the subject matter as defined by the appended claims and equivalents thereof. Throughout the specification, the same or like reference numerals designate the same or like elements. Furthermore, terms which will be described herein are terms defined in consideration of the functions in the disclosure, and may be different according to users, intentions of the operators, or customs. Therefore, the definitions of the terms should be made based on the contents throughout the specification.

Herein, it will be understood that each block of flowchart illustrations, and combinations of blocks in the flowchart illustrations, may be performed based on computer program instructions. These computer program instructions may be loaded collectively onto at least one processor of a general purpose computer, special purpose computer, or other programmable data processing apparatus to produce a machine, such that the instructions, which perform through any one of, or in any combination of, the at least one processor of the computer or other programmable data processing apparatus, create means for performing the functions specified in the flowchart block(s). These computer program instructions may also be stored in a non-transitory computer usable or computer-readable memory that may direct a computer or other programmable data processing apparatus to function in a particular manner, such that the instructions stored in the computer usable or computer-readable memory produce an article of manufacture including instruction means that perform the function specified in the flowchart block(s). The computer program instructions may also be loaded onto a computer or other programmable data processing apparatus to cause a series of operational steps to be performed on the computer or other programmable data processing apparatus to produce a computer executed process such that the instructions that perform on the computer or other programmable data processing apparatus provide steps for executing the functions specified in the flowchart block(s).

Further, each block may represent a module, segment, or portion of code, which includes one or more executable instructions for executing the specified logical function(s). It should also be noted that in some alternative implementations, the functions noted in the blocks may occur out of the order. For example, two blocks (or functions) shown in succession may in fact be performed substantially concurrently or the blocks may sometimes be performed in the reverse order, depending upon the functionality involved.

As used in embodiments of the disclosure, a “~unit/module” may refer to a software element or a hardware element, such as a field programmable gate array (FPGA) or an application specific integrated circuit (ASIC), which performs a predetermined function. However, the term including the word “~unit/module” does not always have a meaning limited to software or hardware. The “~unit/module” may be constructed either to be stored in an addressable storage medium or to execute one or more processors. Therefore, the “~unit/module” includes, for example, software elements, object-oriented software elements, components such as class elements and task elements, processes, functions, properties, procedures, sub-routines, segments of a program code, drivers, firmware, micro-codes, circuits, data, database, data structures, tables, arrays, and parameters. The components and functions provided by the “~unit/module” may be either combined into a smaller number of components and a “~unit/module,” or divided into additional components and a “~unit/module.” Moreover, the components and “~units/modules” may be implemented to reproduce one or more central processing units (CPUs) within a device or a security multimedia card. Further, in the embodiments, the “~unit/module” may include one or more processors.

The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a CPU), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, microprocessors, microcontrollers, digital signal processors, FPGA, ASIC, a microprocessor unit (MPU), a system on chip (SoC), an IC, or the like. The one processor or the combination of processors executes instructions that can be stored in a memory, such as the operating system, in order to control the overall operation of the device. Also, the one processor or the combination of processors is also capable of executing other processes and programs resident in the memory, such as processes for the disclosure.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure. Additionally, or alternatively, such software may be a computer program [product] comprising instructions which, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments of the present disclosure may provide a program comprising code for implementing apparatus or a method as claimed in any one of the claims of this specification and a non-transitory machine-readable storage storing such a program.

Hereinafter, the determination of priority between A and B in the present disclosure may refer to various actions such as selecting the one having a higher priority based on a predefined priority rule and performing an operation corresponding thereto, or omitting or dropping an operation corresponding to the one having a lower priority.

Hereinafter, “A or B” as described in the present disclosure may be understood as “A and/or B,” which may include A, or B, or both A and B.

In addition, “at least one of A, B, and C” as described in the present disclosure may be understood to include A, or B, or C, or any combination of A, B, and C.

In addition, “at least one of A, B, or C” as described in the present disclosure may be understood to include A, or B, or C, or any combination of A, B, and C.

Furthermore, “A/B” as described in the present disclosure may be understood as “A and/or B,” which may include A, or B, or both A and B.

Furthermore, “A, B” as described in the present disclosure may be understood as “A and/or B,” which may include A, or B, or both A and B.

Furthermore, “A and B” as described in the present disclosure may be understood as “A and/or B,” which may include A, or B, or both A and B.

Furthermore, “if condition A and condition B are satisfied,” as described in the present disclosure, may not be limited to a case where both condition A and condition B are satisfied, but may be understood to include a case where either condition A or condition B is individually satisfied, both condition A and condition B are satisfied, or one or more additional conditions are satisfied in combination.

Furthermore, throughout this disclosure, ordinal terms such as “first,” “second,” “third,” etc., (and similar qualifiers) are used merely to distinguish between different instances, occurrences, configurations, messages, stages, elements or aspects of elements, operations, or information as described herein. Unless the context clearly dictates otherwise, the use of such ordinal terms does not itself require that the elements, operations, or information distinguished by these terms be structurally different, numerically distinct, or substantively dissimilar. For example, a “first signal” and a “second signal” may refer to instances of the same signal transmitted at different times or containing the same core information despite minor variations, or they may refer to signals with different content or characteristics, depending on the specific context. Similarly, a “first value” and a “second value” may represent the same magnitude but measured or applied in different circumstances, or they may represent different magnitudes. The interpretation should be guided by the specific technical context, function, and relationship described in the relevant portion of the specification and claims.

Furthermore, the terms “first ~,” “second ~,” etc., as described in the present disclosure with respect to various elements (e.g., information, objects, operation, sequences, or the like), should not limit those elements. These terms may only be intended to distinguish one element from another, and may not be intended to indicate a specific order. For example, a first element could be termed a second element, and, similarly, a second element could be termed a first element.

Furthermore, even if “first ~” and “second ~” are described in the present disclosure, it may be understood that element(s) referred to by “first ~” and “second ~” may be the same or different. For example, in case of element(s) being information, first information and second information may both be same information and, in some cases, are separate and different information.

In addition, the terms “if ~” and “in case that ~” as used in the disclosure or claims may be interpreted to include the meanings of “when (or upon) ~,” “in response to ~,” “based on ~,” or “according to ~,” and may be used interchangeably with these expressions. In addition, expressions other than those exemplified herein may also be used, as long as they have substantially the same meaning and do not impair the technical features of the present disclosure. If a method step (e.g., transmit a signal) is performed according to the disclosure of the application in connection with one of the above terms (such as “in case that ~” or the like), it may be interpreted to include the meanings (disclosure) of a prior determination that a feature has a specific state “~” (e.g., a bit length is above X), and then perform the method step in response to said determination.

For example, the physical layer signaling may be referred to as layer 1 (L1) signaling and may include downlink control information (DCI). In addition, the higher layer signaling may include a medium access control (MAC) control message, a radio resource control (RRC) signaling message, a non-access stratum (NAS) signaling message, or an application layer message. The RRC signaling message may be referred to as L3 (layer 3) signaling. It should be noted, however, that the higher layer signaling is not limited to the aforementioned examples.

In addition, the term “not perform” as used in the present disclosure or claims may, in context, be understood to mean that the corresponding step is omitted or skipped. Such a term may be replaced with other terms having the same or substantially equivalent meaning.

In addition, “transmitting a message including A and B” as described in the present disclosure, may be understood as encompassing both (i) transmitting A and B in a single message, and (ii) transmitting A and B separately via multiple messages (e.g., transmitting a first message including A and a second message including B). This interpretation may also apply to messages that include two or more items (e.g., A, B, C), transmitted either together or separately.

In addition, “transmitting a message including A and transmitting a message including B” may also be interpreted as transmitting a message including A and B in a single message.

In the embodiments of the present disclosure described herein, terms or components included in the disclosure may be expressed in singular or plural form depending on the specific embodiments presented. However, such singular or plural expressions are selected appropriately for convenience of description, and the present disclosure is not limited to a singular or plural number of components. A component expressed in the plural form may be implemented as a single component, and a component expressed in the singular form may be implemented as multiple components.

The drawings or flowcharts described herein illustrate example methods that may be implemented according to the principles of the present disclosure, and various modifications may be made to the methods illustrated in the flowcharts of the present disclosure. For example, although illustrated as a series of steps, various steps in each drawing or flowchart may overlap, occur in parallel, occur in a different order, or be repeated. In other examples, any step may be omitted or replaced with another step.

The process of the flowchart may be performed by a device. One or more of the steps of the flowchart can be implemented by one or more processors/computer programs executing instructions to perform the noted functions.

The methods and apparatuses provided in the embodiments of the present disclosure may be disclosed in connection with drawings disclosing flowcharts to illustrate example methods that may be implemented according to the principles of the present disclosure. Such flowcharts may contain different branches and/or sub-branches. It is understood that the principles of the present disclosure do not only contain the combination of all branches/sub-branches disclosed in the embodiment, but the present disclosure also contains at least one isolated branch/isolated sub-branch, in particular to a single branch/single sub-branch.

The methods and apparatuses provided in the embodiments of the present disclosure are not limited to each embodiment individually, but may also be applied in combination of all or some of the embodiments provided in the disclosure. Therefore, the embodiments of the present disclosure may be modified and applied without significantly departing from the scope of the present disclosure, as would be understood by those skilled in the art.

In this case, even if certain wordings are described differently across embodiments, they may be used interchangeably or in substitution or in combination if their underlying concepts are equivalent. For example, for the same or equivalent concept, even if one embodiment uses the expression “A” and another embodiment uses the expression “B,” such expressions may be understood interchangeably, in substitution, or in combination.

The terms used in the following description to refer to access nodes, network entities, messages, interfaces between network entities, various types of identification information, and the like, are provided merely for the convenience of explanation by way of example. Therefore, the present disclosure is not limited to the terms described herein, and other terms having equivalent technical meanings may also be used. Such terms may also be interchangeable with terms defined in any 3rd generation partnership project (3GPP) technical specifications (TS) or similar technical specifications, e.g., from the European telecommunications standards institute (ETSI), where appropriate.

Hereinafter, a base station (BS) is an entity that allocates resources to terminals, and may be at least one of a gNode B, an eNode B, a Node B, a wireless access unit, a BS controller, or a node on a network.

Furthermore, the base station of the present disclosure may include a split architecture comprising a central unit (CU) and a distributed unit (DU). In this structure, the CU is configured to process the higher layers of the control and user planes, while the DU is configured to process lower-layer radio resource functions. The embodiments of the present disclosure may be equally applicable to 5th generation (5G) base station architectures in which such CU and DU functional splits are implemented.

A terminal may include a user equipment (UE), a mobile station (MS), a cellular phone, a smartphone, a computer, a tablet, a wearable device, an Internet of Things (IoT) device, or any other device/system capable of performing communication functions.

In the disclosure, a downlink (DL) refers to a radio link through which a BS transmits a signal to a terminal, and an uplink (UL) refers to a radio link through which a terminal transmits a signal to a BS.

Furthermore, hereinafter, 5G mobile communication technologies (e.g., 5G new radio (NR)), 6th generation (6G) mobile communication technologies may be described by way of example, but the embodiments of the present disclosure may also be applied to other communication systems having similar technical backgrounds or channel types. For example, newly evolved mobile communication systems developed after 5G and 6G may be included. Furthermore, based on determinations by those skilled in the art, the embodiments of the present disclosure may also be applied to other communication systems (e.g., Wi-Fi systems) through some modifications without significantly departing from the scope of the present disclosure

In the following description, the terms physical channel and signal may be used interchangeably with data or control signal. For example, the term physical downlink shared channel (PDSCH) refers to a physical channel through which data is transmitted, but the term PDSCH may also be used to refer to the data itself. That is, in the present disclosure, the expression “transmit a physical channel” may be interpreted as being equivalent to the expression “transmit data or a signal via a physical channel.”

Hereinafter, in the context of the present disclosure, higher layer signaling may refer to signaling corresponding to at least one or any combination of the following: master information block (MIB), system information block (SIB) or SIB M (M=1, 2, . . . ), RRC, or MAC control element (CE), or a non-access stratum (NAS) signaling message, or an application layer message. The RRC signaling message may be referred to as layer 3 (L3) signaling.

In addition, L1 signaling may refer to signaling corresponding to at least one or any combination of signaling techniques using the at least one or any combination of the following physical layer channels or signaling: physical downlink control channel (PDCCH), DCI, UE-specific DCI, group-common DCI, common DCI, scheduling DCI (e.g., DCI used for scheduling downlink or uplink data), non-scheduling DCI (e.g., DCI not used for scheduling downlink or uplink data) physical uplink control channel (PUCCH), or uplink control information (UCI). The L1 signaling message may be referred to as a physical layer signaling.

Hereinafter, the expression that information is configured by the BS, as used in the present disclosure or claims, may, in context, be understood to mean that the terminal receives the corresponding information from the BS via a physical layer signaling or a higher layer signaling. Such an expression may be replaced with other terms having the same or substantially equivalent meaning.

Hereinafter, the operational principle of the present disclosure will be described in detail with reference to the accompanying drawings.

Meanwhile, in 5G, in order to optimize transmission beamforming of a UE, non-codebook based beamforming (NCB) and codebook based beamforming (CBB) are supported. Using non-codebook based beamforming, a UE may freely form a beam and transmit the beam to a base station. For example, the UE may acquire channel information by receiving a CSI-RS transmitted from the base station, and may determine candidate beams to be used for uplink transmission based on the acquired channel information, without being constrained by a codebook. The UE may transmit the determined beams to the base station by using respective SRS resources. The base station may, by receiving the plurality of SRS signals, select and/or determine beams to be used for uplink transmission, and may inform the UE of the selected and/or determined beams through DCI. Although non-codebook based beamforming provides an advantage in that beams can be flexibly adjusted depending on various channel conditions, it has a disadvantage in that signaling overhead between the UE and the base station may increase. On the other hand, when codebook based beamforming is used, the base station may perform channel estimation based on SRS transmitted by the UE without transmitting CSI-RS, and may select a specific beam from a predefined codebook and notify the UE of the selected beam through DCI. Accordingly, compared to the non-codebook based beamforming scheme, signaling overhead can be reduced. Although codebook based beamforming does not provide flexibility in beam adjustment, it provides advantages in that signaling overhead is reduced and the base station can efficiently manage beams of multiple UEs.

Codebook-based uplink transmission may be performed based on a process as described below.

A user equipment (UE) performs transmission of a sounding reference signal (SRS) to a base station (BS).

The BS estimates channel state information (CSI), based on the SRS transmitted by the UE.

Based on the estimated CSI, the BS determines, according to a codebook, a transmit precoding matrix indicator (TPMI) beam and the number of layers to be used by the UE for uplink transmission.

The BS delivers information on the determined TPMI index and the number of layers to the UE through downlink control information (DCI).

Meanwhile, the uplink codebook may follow 3GPP TS 38.211.

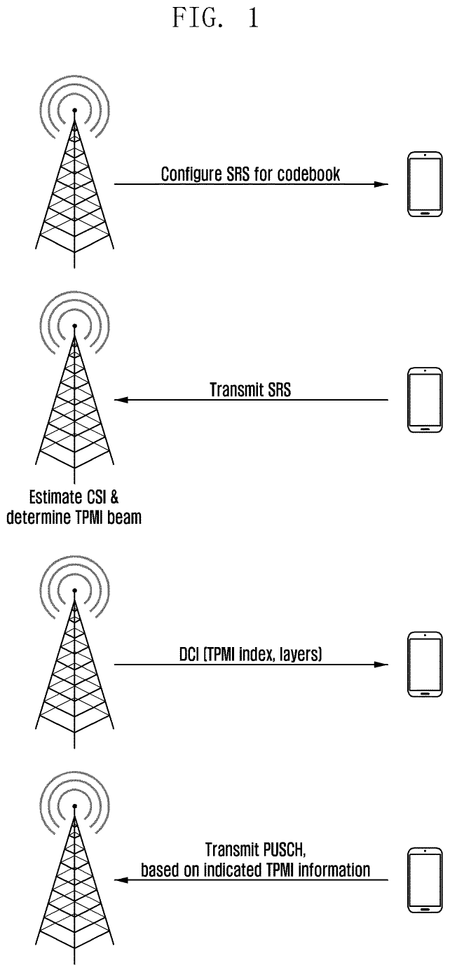

FIG. 1 illustrates an embodiment of codebook-based uplink transmission according to an embodiment of the present disclosure.

Referring to FIG. 1, a BS may provide, to a UE, a configuration of SRS resource information configured based on SRS usage={codebook}. The SRS resource information may include an SRS resource set and SRS resources. The SRS usage information may be included in the SRS resource set. The SRS resources may be, for example, periodic, semi-persistent, or aperiodic. The UE may transmit an SRS, based on the SRS resource information, and the BS may estimate channel state information (CSI) by receiving the SRS. Based on the estimated CSI, the BS may determine a TPMI beam and a number of layers for uplink transmission by the UE. For example, the BS may select a TPMI beam that maximizes the signal strength of the estimated CSI. In addition, the BS may determine a number of layers that maximizes spectral efficiency, based on the estimated CSI and the TPMI beam. The BS may deliver, to the UE through DCI, a TPMI index corresponding to the determined TPMI beam and the number of layers, together with uplink resource information for performing uplink transmission. Here, the TPMI index may follow 3GPP TS 38.212. The UE may perform uplink transmission based on the TPMI beam and the number of layers corresponding to the indicated TPMI index.

Meanwhile, in the codebook-based uplink transmission method, since uplink transmission is performed by using only TPMI beams included in the uplink codebook indicated by the BS, the uplink beam directions may be limited. Accordingly, the codebook-based uplink transmission method may be limited in maximizing uplink multi-user MIMO (MU-MIMO) transmission performance. For example, uplink MU-MIMO transmission performance may be maximized when the correlation among channels of UEs is low. However, since values for each element of a TPMI beam vector are already determined by the codebook, it may not be suitable for minimizing the correlation among channels of UEs in consideration of dynamically varying UE channel conditions.

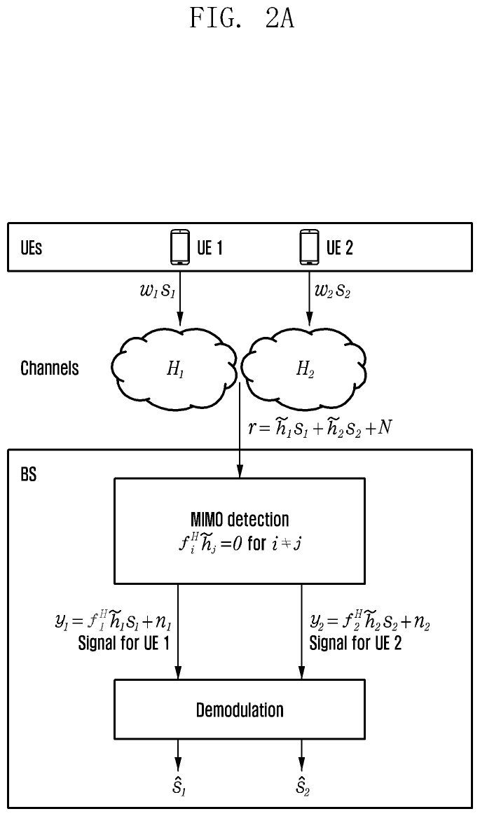

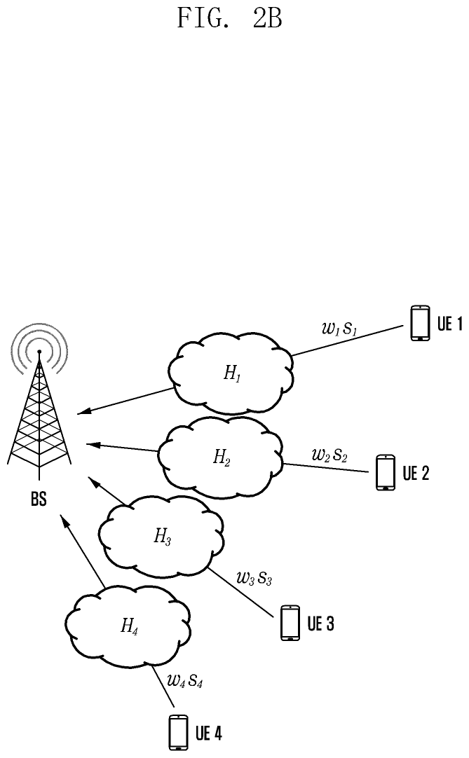

FIG. 2A illustrates an example of uplink MU-MIMO transmission and reception for two UEs according to an embodiment of the present disclosure.

Referring to FIG. 2A, UE 1 may transmit a data symbol s₁ using a TPMI beam w₁ indicated by the BS. Further, UE 2 may transmit a data symbol s₂ using a TPMI beam w₂ indicated by the BS. According to the transmissions of UE 1 and UE 2, a received signal r by the BS may be expressed as r=\tilde{h}₁s₁+\tilde{h}₂s₂+N. Here, \tilde{h}₁ denotes effective channel information H₁w₁ to which the TPMI beam w₁ of UE 1 is applied, where H₁ denotes a channel matrix between the BS and UE 1. Similarly, \tilde{h}₂ denotes effective channel information H₂w₂ to which the TPMI beam w₂ of UE 2 is applied, where H₂ denotes a channel matrix between the BS and UE 2. The BS may maximize received signal strength or minimize interference strength, based on a MIMO detection technique. For example, the BS may receive a signal, based on zero-forcing (ZF) MIMO detection. When the BS applies a ZF receive beam, the impact of inter-UE interference may be minimized. Meanwhile, by means of a Gram-Schmidt process, a receive beam of the BS for UE 1 may be expressed as f₁=\tilde{h}₁−u_{1,2}, where u_{1,2} is a vector required to minimize interference caused by a signal transmitted from UE 2 prior to performing demodulation of a data symbol of UE 1, and may be expressed as

$${u}_{1 , 2} = \frac{{\tilde{h}}_{2}}{{‖ {\tilde{h}}_{2} ‖}^{2}} \cdot ( {\tilde{h}}_{2}^{H} \cdot {\tilde{h}}_{1} ) .$$

Similarly, by means of a Gram-Schmidt process, a receive beam of the BS for UE 2 may be expressed as f₂=\tilde{h}₂−u_{2,1}, where u_{2,1} is a vector required to minimize interference caused by a signal transmitted from UE 1 prior to performing demodulation of a data symbol of UE 2, and may be expressed as

$${u}_{2 , 1} = \frac{{\tilde{h}}_{1}}{{‖ {\tilde{h}}_{1} ‖}^{2}} \cdot ( {\tilde{h}}_{1}^{H} \cdot {\tilde{h}}_{2} ) .$$

FIG. 2B illustrates an example of uplink MU-MIMO transmission and reception for four UEs according to an embodiment of the present disclosure.

Referring to FIG. 2B, UE 1 may transmit a data symbol s₁ using a TPMI beam w₁ indicated by the BS. Further, UE 2 may transmit a data symbol s₂ using a TPMI beam w₂ indicated by the BS. In addition, UE 3 may transmit a data symbol s₃ using a TPMI beam w₃ indicated by the BS. Furthermore, UE 4 may transmit a data symbol s₄ using a TPMI beam w₄ indicated by the BS. According to the transmissions by UE 1 to UE 4, a received signal r by the BS may be expressed as r=\tilde{h}₁s₁+\tilde{h}₂s₂+\tilde{h}₃s₃+\tilde{h}₄s₄+N. Here, \tilde{h}₁ denotes effective channel information H₁w₁ to which the TPMI beam w₁ of UE 1 is applied, where H₁ denotes a channel matrix between the BS and UE 1. Similarly, \tilde{h}₂, \tilde{h}₃, and \tilde{h}₄ respectively denote effective channel information H₂w₂, H₃w₄, and H₄w₄ to which TPMI beams w₂, w₃, and w₄ of UE 2, UE 3, and UE 4 are applied, where H₂, H₃, and H₄ respectively denote channel matrices between the BS and UE 2, the BS and UE 3, and the BS and UE 4. The BS may maximize received signal strength or minimize interference strength, based on a MIMO detection scheme. In a case of performing uplink MU-MIMO when there are four UEs, a ZF reception beam f₁ for UE 1 may be expressed, according to a Gram-Schmidt process, as f₁=\tilde{h}₁−u_{1,2}−u_{1,3}−u_{1,4}. Here,

$${u}_{1 , 2} = \frac{{\tilde{h}}_{2}}{{‖ {\tilde{h}}_{2} ‖}^{2}} \cdot ( {\tilde{h}}_{2}^{H} \cdot {\tilde{h}}_{1} ) , {u}_{1 , 3} = \frac{{z}_{3}}{{‖ {z}_{3} ‖}^{2}} \cdot ( {z}_{3}^{H} \cdot {\tilde{h}}_{1} ) , and {u}_{1 , 4} = \frac{{z}_{4}}{{‖ {z}_{4} ‖}^{2}} \cdot ( {z}_{4}^{H} \cdot {\tilde{h}}_{1} ) .$$

In addition.

$${z}_{3} = {\tilde{h}}_{3} - \frac{{\tilde{h}}_{2}}{{‖ {\tilde{h}}_{2} ‖}^{2}} \cdot ( {\tilde{h}}_{2}^{H} \cdot {\tilde{h}}_{3} ) , and {z}_{4} = {\tilde{h}}_{4} - \frac{{\tilde{h}}_{2}}{{‖ {\tilde{h}}_{2} ‖}^{2}} \cdot ( {\tilde{h}}_{2}^{H} \cdot {\tilde{h}}_{4} ) - \frac{{z}_{3}}{{‖ {z}_{3} ‖}^{2}} \cdot ( {z}_{3}^{H} \cdot {\tilde{h}}_{4} ) .$$

In summary, the BS may minimize interference between UEs based on zero-forcing (ZF) detection. To remove interference, the BS may apply correction vectors (u vectors) in a Gram-Schmidt orthogonalization process. When the BS applies the correction vectors, the strength of the received signal at the BS may decrease, and such a decrease in signal strength may be defined as MU nulling loss.

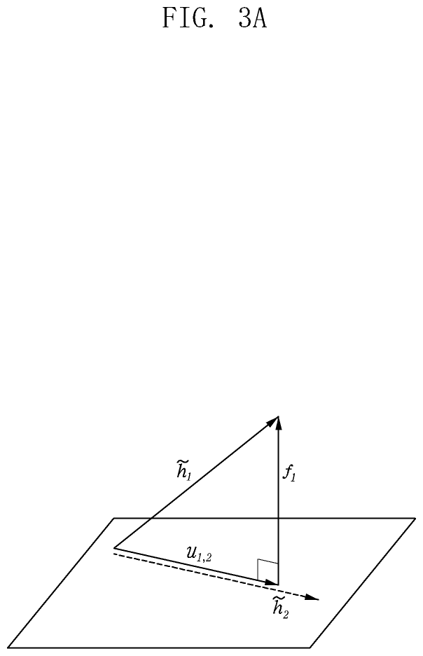

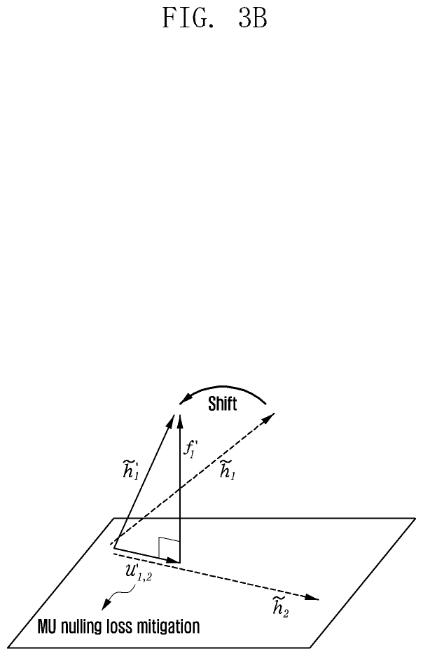

FIG. 3A illustrates an example of relationships among \tilde{h}₁, \tilde{h}₂, f₁ and u_{1,2} according to FIG. 2A.

Referring to FIG. 3, as the correlation of the effective channels of the UEs,

$${\tilde{h}}_{2}^{H} \cdot {\tilde{h}}_{1} ,$$

becomes smaller, the magnitude of u_{1,2} may decrease. In addition, as the magnitude of u_{1,2} decreases, the BS may receive data in a direction closer to the effective channel of UE 1, and therefore the signal-to-interference-plus-noise (SINR) for the data symbol of UE 1 may increase. For example, based on the situation illustrated in FIG. 2A, when the correlation

$$( {\tilde{h}}_{2}^{H} \cdot {\tilde{h}}_{1} )$$

is 0 (that is, when, \tilde{h}₁ and \tilde{h}₂ are orthogonal), u_{1,2} may have a value of 0. When the value of u_{1,2} is 0, the BS may optimally receive the data symbol for UE 1 (or perform maximal ratio combining (MRC), with f₁=\tilde{h}₁). For example, when the correlation

$$( {\tilde{h}}_{2}^{H} \cdot {\tilde{h}}_{1} )$$

of effective channels of respective UEs is 1 (that is, when \tilde{h}₁ and \tilde{h}₂ are parallel), u_{1,2} becomes equal to f₁, causing f₁=0, and therefore the BS may fail to receive the data symbol for UE 1. The case of UE 2 may be interpreted in the same manner as that of UE 1.

Referring to the above example of uplink MU-MIMO transmission and reception for two UEs, it may be identified that uplink MU-MIMO transmission performance may increase as the correlation between channels to which the TPMI beams of the UEs are applied becomes smaller. In the case of uplink MU-MIMO transmission and reception for four UEs, similar to the case of two UEs, it may be expected that, as the correlation between channels among the UEs decreases and thus the magnitudes of the u vectors decrease, uplink MU-MIMO transmission performance increases.

Through the above examples of MU-MIMO transmission and reception, it may be identified that uplink MU-MIMO performance may increase as the correlation between effective channels to which TPMI beams are applied becomes smaller. However, when uplink transmission is performed by using only TPMI beams defined in a codebook, the number of beam directions is limited, and therefore there is a limitation in minimizing channel correlation among UEs. For example, when a beam vector for minimizing uplink MU-MIMO performance (or, for minimizing the magnitude of a u vector) in a 2-port UE is [0.0611+0.5232i, 0.3061+0.3744i, 0.0922+0.5713i, 0.1653+0.3555i], the vector may not be defined in an uplink codebook. As the vector is not defined in the uplink codebook, uplink transmission may not be performed by the UE using the vector. Accordingly, in order to increase uplink MU-MIMO transmission performance, an additional scheme may be considered for the UE to perform uplink transmission using the vector. In other words, in order to increase uplink MU-MIMO transmission performance, an additional scheme may be considered to reduce nulling loss.

FIG. 3B illustrates an example of relationships among \tilde{h}₁, \tilde{h}₂, f₁, and u_{1,2} in a case where an uplink MIMO transmission and reception method apply according to an embodiment of the disclosure.

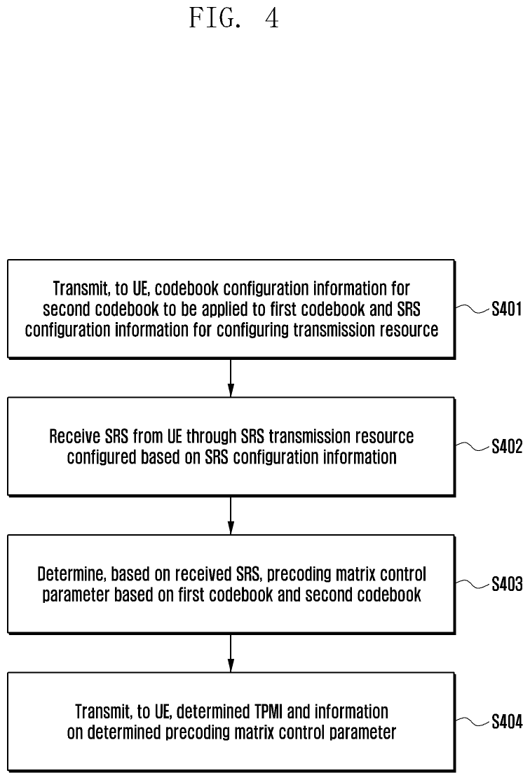

Referring to FIG. 3B, when uplink MIMO transmission and reception is performed based on an uplink MIMO transmission and reception method according to an embodiment of the disclosure, the BS may determine a beam vector that can minimize nulling loss (or minimize the magnitude of a u vector) by not limiting the beam vector for a UE to a TPMI beam defined in a codebook. Hereinafter, with reference to FIGS. 4 to 13, methods for performing uplink MIMO transmission and reception according to various embodiments of the disclosure will be described in detail. In the following description, the codebook defining the TPMI beam may be defined as a first codebook.

The terms used in the disclosure are used merely to describe particular embodiments, and may not be intended to limit the scope of other embodiments. A singular expression may include a plural expression unless they are definitely different in a context. The terms used herein, including technical and scientific terms, may have the same meaning as those commonly understood by a person skilled in the art to which the disclosure pertains. Such terms as those defined in a generally used dictionary may be interpreted to have the meanings equal to the contextual meanings in the relevant field of art, and are not to be interpreted to have ideal or excessively formal meanings unless clearly defined in the disclosure. In some cases, even the term defined in the disclosure should not be interpreted to exclude embodiments of the disclosure.

Hereinafter, various embodiments of the disclosure will be described based on an approach of hardware. However, various embodiments of the disclosure include a technology that uses both hardware and software, and thus the various embodiments of the disclosure may not exclude the perspective of software.

FIG. 4 illustrates a flowchart of an uplink MIMO transmission and reception method according to an embodiment of the disclosure. More specifically, FIG. 4 illustrates an example of an operation of a base station for implementing an uplink MIMO transmission and reception method according to an embodiment of the disclosure.

In operation S401, the base station may transmit, to a UE, codebook configuration information regarding a second codebook to be applied to a first codebook, and sounding reference signal (SRS) configuration information for configuring SRS transmission resources. The codebook configuration information may be defined with various names, such as second codebook configuration information or enhanced uplink (UL) codebook configuration, and is not limited to the terms used in the disclosure. Likewise, the second codebook may be defined with various names, such as enhanced codebook or enhanced UL codebook, and is not limited to the terms used in the disclosure. The base station may transmit the codebook configuration information and/or the SRS configuration information to the UE through an RRC message. Here, as described above, the first codebook may define transmitted precoding matrix indicator (TPMI) beams. For example, the first codebook may define precoding matrices for various cases such as a 2-port UE, a 4-port UE, or an 8-port UE, and indices corresponding to the precoding matrices. Meanwhile, the second codebook may define various parameters to be applied to the first codebook. For example, the second codebook may define various parameters to be applied to a precoding matrix according to the first codebook, and indices corresponding to the parameters. The various parameters may include, for example, amplitude adjustment parameters and/or phase adjustment parameters.

The codebook configuration information for the second codebook may include information indicating whether the second codebook is to be applied, and may additionally include at least one of the following types of information:
Amplitude adjustment on/off indicator: an indicator for instructing activation or inactivation of an amplitude control function for controlling the amplitude of a precoding matrix defined by the first codebook;
Phase adjustment on/off indicator: an indicator for instructing activation or inactivation of a phase control function for controlling the phase of a precoding matrix defined by the first codebook;
Information regarding an initial amplitude offset: information on an initial offset value for amplitude adjustment when the amplitude of a precoding matrix is cyclically adjusted;
Information regarding an initial phase offset: information on an initial offset value for phase adjustment when the phase of a precoding matrix is cyclically adjusted;
Information regarding a step size of amplitude change: information related to configuring the size of an amplitude adjustment step when the amplitude of a precoding matrix is cyclically adjusted. The information may include a step size, a quantization level, a step adjustment period, and the like;
Information regarding a step size of phase change: information related to configuring the size of a phase adjustment step when the phase of a precoding matrix is cyclically adjusted. The information may include a step size, a quantization level, a step adjustment period, and the like;
Information regarding an applicable amplitude super set: when the amplitude of a precoding matrix is adjusted based on a table, this refers to information on an amplitude super set including an amplitude subset configured by at least one amplitude control parameter applicable to the precoding matrix;
Information regarding an applicable phase super set: when the phase of a precoding matrix is adjusted based on a table, this refers to information on a phase super set including a phase subset configured by at least one phase control parameter applicable to the precoding matrix;
Port group size for amplitude adjustment: information indicating the number of UE ports included in each of units to which different amplitudes are to be applied. In other words, this refers to information regarding a group including at least one antenna port, to which the same amplitude control parameter is to be applied, among elements of a precoding matrix; and
Phase group size for phase adjustment: information indicating the number of UE ports included in each of units to which different phases are to be applied. In other words, this refers to information regarding a group including at least one antenna port, to which the same phase control parameter is to be applied, among elements of a precoding matrix.

The enhanced uplink codebook configuration information may provide amplitude/phase control functions by using an amplitude/phase table or a super set. On the other hand, the enhanced uplink codebook configuration information may provide cyclic amplitude/phase control functions by using information related to amplitude/phase step sizes.

As a specific example, enhanced uplink codebook configuration information may be configured as shown in Table 1 below.

TABLE 1

PUSCH-Config ::= SEQUENCE {
dataScramblingIdentityPUSCH 2
txConfig = codebook
enhancedULcodebookIndicator = {enabled}
enhancedULcodebook {
Amplitude adjustment {enabled}
Phase adjustment {enabled}
}
AmplitudeConfig {
Amplitude combination table
Group size for amplitude adjustment = 2}
}
PhaseConfig {
Phase offset (p_off) = 0.03
Phase index step (Δm) = 2
Phase quantization level(N) = 4
Number of phase values (P) = 8
Group size for phase adjustment = 1}
}
...}

Referring to Table 1, the BS may instruct the UE whether to apply an enhanced codebook by UL using enhancedULcodebookIndicator. For example, when enhancedULcodebookIndicator={enabled} is configured, the UE may identify that PUSCH transmission based on an enhanced UL codebook is to be performed. On the other hand, when enhancedULcodebookIndicator={disabled} is configured, the UE may identify that PUSCH transmission not using an enhanced UL codebook is to be performed.

In the example according to Table 1, enhanced UL codebook configuration information may be defined in an enhancedULcodebook field. As can be seen in Table 1, the enhancedULcodebook field may be configured by including at least one of Amplitude adjustment, Phase adjustment, AmplitudeConfig, and PhaseConfig. When Amplitude adjustment={enabled}, the UE may identify that PUSCH transmission is to be performed based on activation of amplitude adjustment. On the other hand, when Amplitude adjustment={disabled}, the UE may identify that PUSCH transmission is to be performed based on inactivation of amplitude adjustment. In addition, when Phase adjustment={enabled}, the UE may identify that PUSCH transmission is to be performed based on activation of phase adjustment. On the other hand, when Phase adjustment={disabled}, the UE may identify that PUSCH transmission is to be performed based on inactivation of phase adjustment. According to Table 1, even when enhancedULcodebookIndicator={enabled}, the BS may configure, for the UE, an enhanced UL codebook such that the BS can selectively activate amplitude adjustment or phase adjustment.

In the example according to Table 1, AmplitudeConfig may include information required for amplitude adjustment. According to the example of Table 1, possible amplitude values may refer to an Amplitude combination table. In addition, the BS may configure, for the UE, an enhanced UL codebook in which a unit of amplitude ports for performing amplitude adjustment is determined based on the group size for amplitude adjustment. For example, when the group size for amplitude adjustment=2, the UE may group two ports into one amplitude port group, and may apply different amplitudes to the respective amplitude port groups. Specifically, in the case of a 4-port UE, a TPMI beam may be determined as w=[w₁, w₂, w₃, w₄]^{T} based on a first codebook, and when group size for amplitude adjustment=2, w1 and w2 may be grouped as amplitude port group 1, and w3 and w4 be grouped as amplitude port group 2. Here, an amplitude ρ₁ may be applied to amplitude port group 1, and an amplitude ρ₂ may be applied to amplitude port group 2. When amplitude adjustment is applied to each amplitude port group, the TPMI beam may be adjusted as w=[ρ₁w1, ρ₁w2, ρ₂w3, ρ₂ w4]^{T}.

Meanwhile, in the above example, although only the example in which, when group size for amplitude adjustment=2, w1 and w2 are grouped as amplitude port group 1 and w3 and w4 are grouped as amplitude port group 2 has been described, the disclosure is not limited thereto, and various methods for configuring, for the UE, a group size for amplitude adjustment by the BS may be defined. For example, when group size for amplitude adjustment=2, it is also possible that odd-numbered ports w1 and w3 are grouped as amplitude port group 1, and even-numbered ports w2 and w4 are grouped as amplitude port group 2. As a specific example, when the number of UE ports is 8 and group size for amplitude adjustment=2, grouping may be performed as {1, 5}, {2, 6}, {3, 7}, and {4, 8}. Alternatively, grouping may also be performed as {1, 3}, {2, 4}, {5, 7}, and {6, 8}.

Here, a rule for performing grouping among antenna ports may be determined based on a prior definition between the UE and the BS, or may be determined based on separate signaling from the BS to the UE. As one example, when the number of UE ports is 8 and the group size for amplitude adjustment is 2, grouping into {1, 5}, {2, 6}, {3, 7}, and {4, 8} may be instructed by configuring the grouping mode to {comb4} (Grouping mode={comb4}). Alternatively, grouping into {1, 3}, {2, 4}, {5, 7}, and {6, 8} may be instructed by configuring the grouping mode to {comb2} (Grouping mode={comb2}.

Meanwhile, as described above, in the example according to Table 1, an amplitude value applied to each amplitude port group may be determined based on an amplitude combination table. The amplitude combination table may be transmitted to the UE through RRC signaling. A specific example of the amplitude combination table may be represented as shown in Table 2.

TABLE 2

| Index | (ρ₁, ρ₂) |
|---|---|
| 0 | (+29 \sqrt{0.25}, +29 \sqrt{1.75}) |
| 1 | (+29 \sqrt{1.75}, +29 \sqrt{0.25}) |
| 2 | (+29 \sqrt{0.5}, √1.5) |
| 3 | (+29 \sqrt{1.5}, √0.5) |
| 4 | (+29 \sqrt{0.75}, √1.25) |
| 5 | (+29 \sqrt{1.25}, √0.75) |
| 6 | (1, 1) |
| 7 | Reserved |

Referring to Table 2, amplitude values applied to each amplitude port group may be provided as table information including amplitude pair combinations that enable power normalization of a TPMI beam vector (∥w∥²=1), taking the power normalization into account. For example, when an amplitude value applied to an amplitude port group is configured as index 1, amplitude control parameters may be determined as

$${ρ}_{1} = 0.2 {5}^{\frac{1}{2}} and {ρ}_{2} = 1.7 {5}^{\frac{1}{2}} .$$

Meanwhile, the base station may instruct the UE to use a specific table among multiple tables pre-configured between the BS and the UE. As one example, when three amplitude combination tables (table 1, table 2, and table 3) are pre-configured, the base station may instruct and signal, to the UE, a table index to be used for amplitude adjustment. According to some examples, the table 1, table 2, and table 3 may have different quantization levels. Specifically, table 1 may be configured by eight possible amplitude combinations (i.e., index=0, . . . , 7), table 2 may be configured by sixteen possible amplitude combinations (i.e., index=0, . . . , 15), and table 3 may be configured by thirty-two possible amplitude combinations (i.e., index=0, . . . , 31). According to some examples, the tables may also be defined for different port group sizes. Specifically, multiple pre-configured tables for port group size=2 and multiple pre-configured tables for port group size=4 may exist separately, and the base station may instruct the UE to use one table index among the pre-configured tables corresponding to the port group size.

Meanwhile, among amplitude control parameter values, a non-integer real number may be signaled in a form of

$$ρ = {a}^{\frac{c}{b}}$$

(where a, b, and c are integers).

In the example according to Table 1, PhaseConfig may include information required for phase adjustment, and specifically may include at least one of information for determining a range of possible phase values and a phase port group size. For example, the BS may configure the enhanced UL codebook for the UE, based on at least one of a phase offset (p_off), a phase index step (Δm), a phase quantization level (N), and a number of phase values (P), which define the range of possible phase values. According to Table 1, the phase range may be determined as shown in Equation 1 below.

$${φ}_{i} = ( {p}_{off} + \frac{Δ m \cdot m}{{2}^{N}} ) 2 π , for m = 0 , 1 , … , P - 1 . \qquad [ Equation 1 ]$$

Meanwhile, unlike Table 1, the BS may provide phase values that can be applied to a precoding matrix based on the first codebook in a form of a table or a superset, and a specific example thereof is shown in Table 3.

TABLE 3

| Index | φ |
|---|---|
| 0 | 0.0118 |
| 1 | 0.7972 |
| 2 | 1.5826 |
| 3 | 2.3680 |
| 4 | 3.1534 |
| 5 | 3.9388 |
| 6 | 4.7242 |
| 7 | 5.5096 |

Referring back to Table 1, the BS may configure, for the UE, a unit of ports used for performing phase adjustment, based on the group size for phase adjustment. For example, when the group size for phase adjustment is 1, the UE may group one port as a single phase port group and apply a different phase to each phase port group. Specifically, in case of a 4-port UE, a TPMI beam may be determined as w=[w1, w2, w3, w4]^{T} based on the first codebook, and when the group size for phase adjustment=1, w1 may be grouped as phase port group 1, w2 may be grouped as phase port group 2, w3 may be grouped as phase port group 3, and w4 may be grouped as phase port group 4. Here, e^{jφ}^{₁} may be applied to phase port group 1, e^{jφ}^{₂} may be applied to phase port group 2, e^{jφ}^{₃} may be applied to phase port group 3, and e^{jφ}^{₄} may be applied to phase port group 4.

According to the example of Table 1, a TPMI beam after amplitude adjustment and phase adjustment are performed may be represented as shown in Equation 2 below.

$${w}^{′} = [ \begin{matrix}{ρ}_{1} {e}^{j {φ}_{1}} {w}_{1} \\ {ρ}_{1} {e}^{j {φ}_{2}} {w}_{2} \\ {ρ}_{2} {e}^{j {φ}_{3}} {w}_{3} \\ {ρ}_{2} {e}^{j {φ}_{4}} {w}_{4}\end{matrix} ] . \qquad [ Equation 2 ]$$

In operation S402, the BS may receive an SRS from the UE through an SRS transmission resource configured based on SRS configuration information. The SRS configuration information may be delivered to the UE through RRC signaling, together with the second codebook configuration information. The SRS configuration information may include SRS resource information. The SRS resource information may include at least one of an SRS resource set and an SRS resource. The SRS resource set may include SRS usage information, and the SRS resource may be configured as periodic, semi-persistent, or aperiodic. The UE may transmit an SRS based on the SRS resource information, and the BS may estimate CSI by receiving the SRS transmitted by the UE.

In operation S403, the BS may, based on the SRS received from the UE, determine a TPMI based on the first codebook and a precoding matrix control parameter based on the second codebook. For example, the BS may determine a TPMI and a control parameter for configuring a beam direction in which the signal strength of CSI estimated based on the SRS received from the UE is maximized. Here, the TPMI may be determined as one of TPMIs defined in the first codebook. The control parameter may be determined based on a method defined through the second codebook.

In operation S404, the BS may transmit, to the UE, information on the determined TPMI and the determined precoding matrix control parameter. For example, the BS may notify the UE, through DCI or MAC-CE signaling, of specific amplitude values and phase values to be applied to UL transmission. Meanwhile, the amplitude values and phase values may vary depending on channel conditions, scheduling conditions, and network states, and when a degree of variation exceeds a threshold, the BS may deliver the control parameters to the UE through DCI or MAC-CE signaling. Alternatively, the BS may deliver the amplitude values and phase values to the UE through DCI or MAC-CE signaling for each scheduled PUSCH.

As a specific example, the BS may deliver to the UE, at least one of an amplitude adjustment index and a phase adjustment index, by including the at least one index in a DCI field. For example, the BS may deliver, through DCI or MAC-CE signaling, information on amplitude adjustment index={1} and phase adjustment index={0, 5, 1, 3} to the UE. Based on the amplitude adjustment index={1}, the UE may apply, to each amplitude port group in the precoding matrix, amplitude values ((ρ₁, ρ₂)−(\sqrt{1.75}, \sqrt{0.25})) corresponding to index 1 of the amplitude combination table of Table 2 configured through the RRC signaling. In addition, based on the phase adjustment index={0, 5, 1, 3}, the UE may sequentially apply, to each phase port group in the precoding matrix, phase values corresponding to indices 0, 5, 1, and 3 of the phase super set of Table 3 configured through the RRC signaling. According to this example, phase values applied to respective phase port groups may be determined as φ₁=0.0118, φ₂=3.9388, φ₃=0.7972, and φ₄=2.3680.

Based on the enhanced UL codebook configuration information configured through the RRC signaling and specific amplitude or phase values instructed through the DCI or MAC-CE, the UE may adjust a TPMI beam w instructed through the DCI to w′ as shown in Equation 3 below.

$${w}^{′} = [ \begin{matrix}{ρ}_{1} {e}^{j {φ}_{1}} {w}_{1} \\ {ρ}_{1} {e}^{j {φ}_{2}} {w}_{2} \\ {ρ}_{2} {e}^{j {φ}_{3}} {w}_{3} \\ {ρ}_{2} {e}^{j {φ}_{4}} {w}_{4}\end{matrix} ] = [ \begin{matrix}\sqrt{1.75} {e}^{j 0.0118} {w}_{1} \\ \sqrt{1.75} {e}^{j 3.9388} {w}_{2} \\ \sqrt{0.25} {e}^{j 0.7972} {w}_{3} \\ \sqrt{0.25} {e}^{j 2.368} {w}_{4}\end{matrix} ] . \qquad [ Equation 3 ]$$

The w′, obtained through amplitude adjustment or phase adjustment, may serve as an adjusted TPMI beam capable of improving UL MU-MIMO transmission performance. For example, amplitude and phase values of a TPMI beam may be adjusted so as to minimize channel correlation among UEs scheduled for UL MU-MIMO. The UE may perform UL signal transmission by using the adjusted TPMI beam determined based on the amplitude adjustment and the phase adjustment.

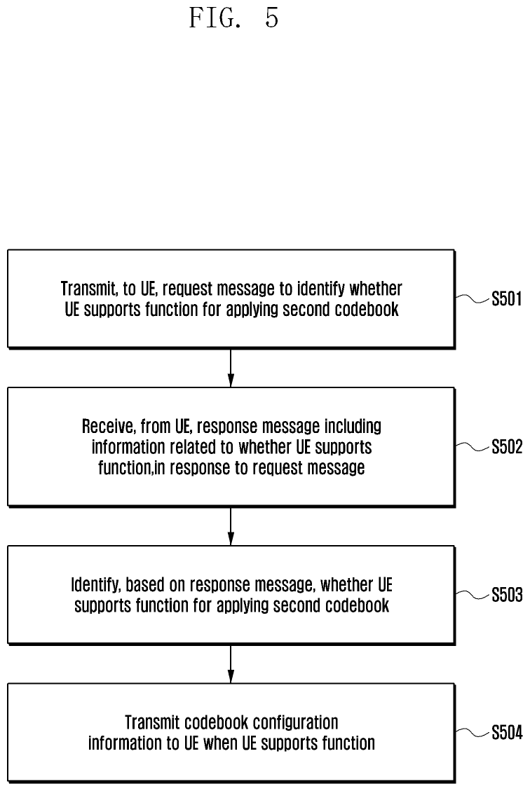

FIG. 5 illustrates a flowchart of an uplink MIMO transmission and reception method according to an embodiment of the disclosure. More specifically, FIG. 5 illustrates an example of an operation in which a BS transmits codebook configuration information according to the uplink MIMO transmission and reception method of an embodiment of the disclosure.

In operation S501, the BS may transmit, to a UE, a request message for identifying whether the UE supports a function (or an enhanced UL codebook) for applying the second codebook.

In operation S502, the BS may receive, from the UE, a response message including information related to whether the UE supports the enhanced UL codebook, in response to the request message. The response message may be configured by including at least one of the following information items.
Enhanced UL codebook {supported, not supported}: information indicating whether the UE supports a function for applying the second codebook.

### <Amplitude Adjustment Capability>

Amplitude adjustment {supported, not supported}: information indicating whether the UE supports an amplitude control function for controlling amplitudes of a precoding matrix defined by the first codebook.
Maximum supported group size for amplitude adjustment: information indicating a maximum value of a group size for amplitude adjustment that the UE can support.
Minimum supported group size for amplitude adjustment: information indicating a minimum value of a group size for amplitude adjustment that the UE can support.
Maximum amplitude value: information indicating a maximum amplitude control value that the UE can apply to a precoding matrix.
Minimum amplitude value: information indicating a minimum amplitude control value that the UE can apply to a precoding matrix.

### <Phase Adjustment Capability>

Phase adjustment {supported, not supported}: information indicating whether the UE supports a phase control function for controlling phases of a precoding matrix defined by the first codebook.
Maximum supported group size for phase adjustment: information indicating a maximum value of a group size for phase adjustment that the UE can support.
Minimum supported group size for phase adjustment: information indicating a minimum value of a group size for phase adjustment that the UE can support.
Maximum phase value: information indicating a maximum phase control value that the UE can apply to a precoding matrix.
Minimum phase value: information indicating a minimum phase control value that the UE can apply to a precoding matrix.

Meanwhile, information that may be included in the above-described response message may be delivered to the BS through RRC signaling (e.g., FeaturesSetUplinkPerCC). As a specific example, the above-described information may be delivered to the BS through FeaturesSetUplinkPerCC, which is configured as shown in Table 4 below.

TABLE 4

FeatureSetUplinkPerCC ::= SEQUENCE {
supportedSubcarrierSpacingUL SubcarrierSpacing,
supportedBandwidthUL SupportedBandwidth,
Enhanced UL codebook {supported, not supported}
Amplitude adjustment capability {
Amplitude adjustment {supported, not supported}
Minimum supported group size for amplitude adjustment
Maximum amplitude value
Minimum amplitude value}
Phase adjustment capability {
Phase adjustment {supported, not supported}
Minimum supported group size for phase adjustment
Maximum phase value
Minimum phase value}
...}

In operation S503, the BS may, based on the response message, identify whether the UE supports the enhanced UL codebook. For example, when enhanced UL codebook={supported}, the BS may identify that the UE supports the enhanced UL codebook.

In operation S504, when the UE supports the enhanced UL codebook, the BS may transmit codebook configuration information to the UE. The codebook configuration information may be configured in a manner similar to that described in operation S401, and detailed descriptions thereof will be omitted. Likewise, when the same or similar descriptions are repeated below, detailed descriptions thereof will also be omitted.

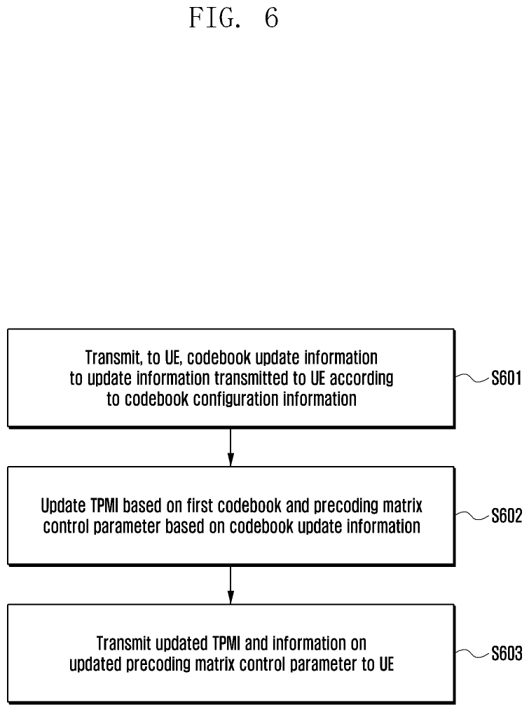

FIG. 6 illustrates a flowchart of an uplink MIMO transmission and reception method according to an embodiment of the disclosure. More specifically, FIG. 6 illustrates an example of an operation in which a BS updates codebook configuration information according to the uplink MIMO transmission and reception method of an embodiment of the disclosure.

In operation S601, the BS may transmit, to a UE, codebook update information for updating pieces of information transmitted to the UE according to the codebook configuration information. For example, the BS may update, by means of a control signal, part of information related to amplitude adjustment or phase adjustment that has been previously configured for the UE. As a specific example, in a situation in which fine tuning of a TPMI beam may be relaxed, such as when the number of UEs in the network is small or when UL MU-MIMO performance is satisfactory, the BS may decrease a super set size of amplitude values or phase values. Alternatively, in a situation in which fine tuning of a TPMI beam may be relaxed, the BS may inactivate amplitude adjustment or phase adjustment. The reduction in the super set size and the inactivation of an adjustment may be independently applied to amplitude adjustment or phase adjustment, respectively. By decreasing the super set size of a specific adjustment or by inactivating a specific adjustment, BS complexity required to find an adjustment coefficient may be reduced, and signaling overhead for informing the UE of amplitude adjustment or phase adjustment information may also be reduced. On the other hand, in a situation in which fine tuning of a TPMI beam may be enhanced, such as when the number of UEs in the network is large or when UL MU-MIMO performance is degraded, the BS may increase the super set size of amplitude values or phase values or may activate a specific adjustment that has been inactivated. The increase in the super set size and the activation of an adjustment may be independently applied to amplitude adjustment or phase adjustment, respectively. When the super set size of a specific adjustment is increased or when a specific adjustment is activated, the complexity of the BS and the signaling overhead may increase, but UL MU-MIMO transmission performance may be improved.

In operation S602, the BS may update a TPMI based on the first codebook and precoding matrix control parameters based on the codebook update information. Here, updating the TPMI and the control parameters may be performed in a manner similar to the method of determining the TPMI and the control parameters described in operation S403.

In operation S603, the BS may transmit, to the UE, the updated TPMI and information regarding the updated precoding matrix control parameters. The updated TPMI and the information regarding the updated precoding matrix control parameters may be transmitted to the UE through DCI or MAC-CE signaling.

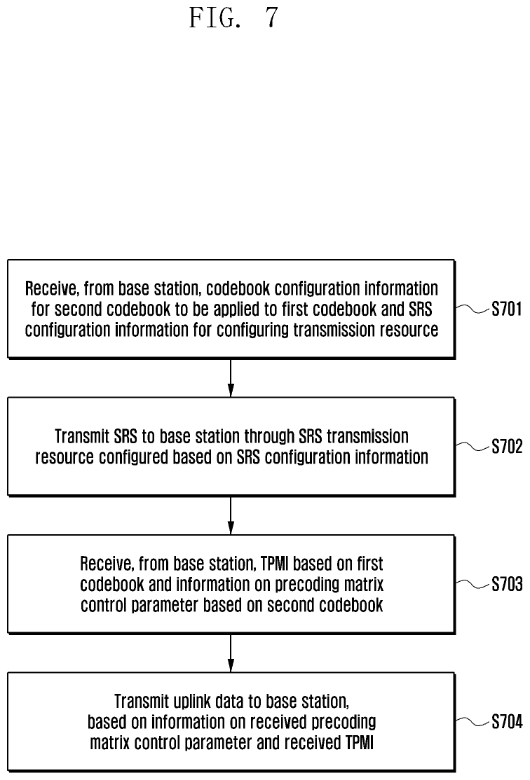

FIG. 7 illustrates a flowchart of an uplink MIMO transmission and reception method according to an embodiment of the disclosure. More specifically, FIG. 7 illustrates an example of an operation of the UE for implementing the uplink MIMO transmission and reception method according to an embodiment of the disclosure.

In operation S701, the UE may receive, from the BS, codebook configuration information regarding a second codebook to be applied to a first codebook and SRS configuration information for configuring an SRS transmission resource. The codebook configuration information and the SRS configuration information may be transmitted from the BS to the UE through RRC signaling, for example. The codebook configuration information and the SRS configuration information may be identical to those described in operation S401.

In operation S702, the UE may transmit, to the BS, an SRS through an SRS transmission resource configured based on the SRS configuration information.

In operation S703, the UE may receive, from the BS, a TPMI based on the first codebook and information regarding precoding matrix control parameters based on the second codebook.

In operation S704, the UE may transmit uplink data to the BS, based on the received TPMI and the received information regarding precoding matrix control parameters. For example, the UE may determine a precoding matrix based on the received TPMI, and may determine a beam direction by adjusting the precoding matrix based on the received information regarding the precoding matrix control parameters. The UE may transmit uplink data to the BS, based on the determined beam direction.

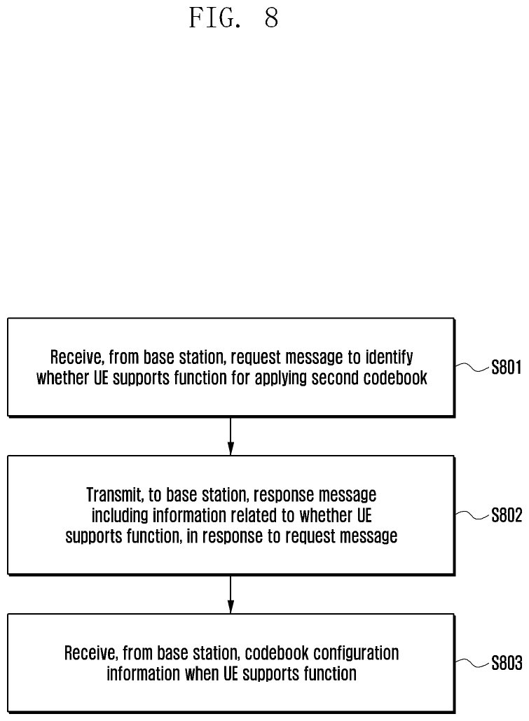

FIG. 8 illustrates a flowchart of an uplink MIMO transmission and reception method according to an embodiment of the disclosure. More specifically, FIG. 8 illustrates an example of an operation of the UE for receiving codebook configuration information according to the uplink MIMO transmission and reception method of an embodiment of the disclosure.

In operation S801, the UE may receive, from the BS, a request message for identifying whether the UE supports a function for applying a second codebook. Here, the request message may be configured in a manner similar to the request message described in operation S501.

In operation S802, the UE may transmit, to the BS, a response message including information related to whether the UE supports the enhanced UL codebook, in response to the request message. Here, the response message may be configured in a manner similar to the response message described in operation S502.

In operation S803, when the UE supports the enhanced UL codebook, the UE may receive an enhanced UL codebook configuration from the BS.

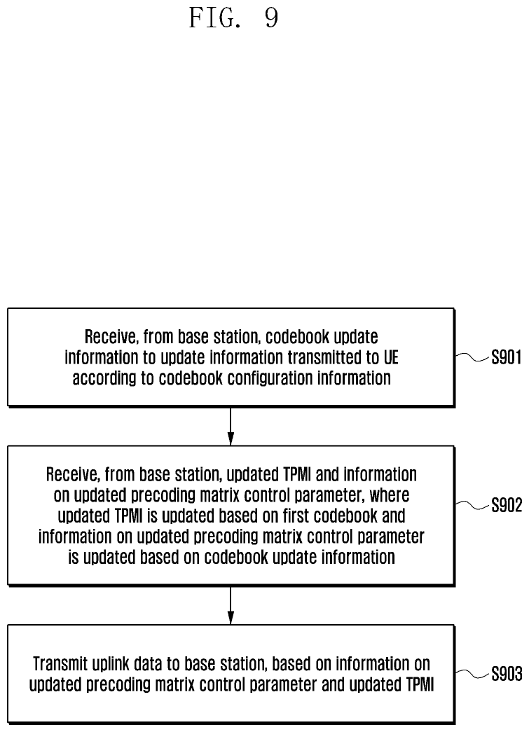

FIG. 9 illustrates a flowchart of an uplink MIMO transmission and reception method according to an embodiment of the disclosure. More specifically, FIG. 9 illustrates an example of an operation of the UE for updating codebook configuration information according to the uplink MIMO transmission and reception method of an embodiment of the disclosure.

In operation S901, the UE may receive, from the BS, codebook update information for updating pieces of information transmitted to the UE according to the codebook configuration information. The codebook update information may be delivered from the BS to the UE via a control signal. The UE may update previously configured codebook configuration information, based on the received codebook update information. The codebook update information may be configured in a manner similar to the codebook update information described in operation S601.

In operation S902, the UE may receive, from the BS, the updated TPMI and information regarding the updated precoding matrix control parameters. Here, the updated TPMI may be updated based on the first codebook, and the information regarding the updated precoding matrix control parameters may be updated based on the codebook update information.

In operation S903, the UE may transmit uplink data to the BS, based on the updated TPMI and the information regarding the updated precoding matrix control parameters. The UE may determine a precoding matrix based on the updated TPMI, and may determine a beam direction by adjusting the precoding matrix based on the information regarding the updated precoding matrix control parameters. The UE may transmit uplink data to the BS, based on the determined beam direction.

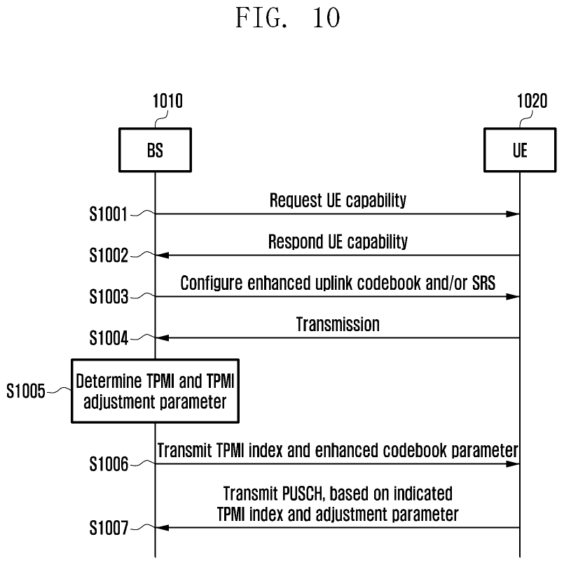

FIG. 10 illustrates a flowchart of an uplink MIMO transmission and reception method according to an embodiment of the disclosure. More specifically, FIG. 10 illustrates an example of specific interactions between a BS 1010 and a UE 1020 for implementing the uplink MIMO transmission and reception method according to an embodiment of the disclosure.

In operation S1001, the BS 1010 may request UE capability information from the UE 1020. For example, the BS 1010 may transmit, to the UE 1020, a request message for requesting the UE capability information.

In operation S1002, the BS 1010 may receive, from the UE 1020, a response message including information related to whether the UE 1020 supports the enhanced UL codebook, in response to the request message. The response message may be configured by including at least one of the following information items, for example:
Enhanced UL codebook {supported, not supported}: information indicating whether the UE 1020 supports a function for applying the second codebook.

### <Amplitude Adjustment Capability>

Amplitude adjustment {supported, not supported}: information indicating whether the UE 1020 supports an amplitude control function for controlling amplitudes of a precoding matrix defined by the first codebook.
Maximum supported group size for amplitude adjustment: information indicating a maximum value of a group size for amplitude adjustment that the UE 1020 can support.
Minimum supported group size for amplitude adjustment: information indicating a minimum value of a group size for amplitude adjustment that the UE 1020 can support.
Maximum amplitude value: information indicating a maximum amplitude control value that the UE 1020 can apply to a precoding matrix.
Minimum amplitude value: information indicating a minimum amplitude control value that the UE 1020 can apply to a precoding matrix.

### <Phase Adjustment Capability>

Phase adjustment {supported, not supported}: information indicating whether the UE 1020 supports a phase control function for controlling phases of a precoding matrix defined by the first codebook.
Maximum supported group size for phase adjustment: information indicating a maximum value of a group size for phase adjustment that the UE 1020 can support.
Minimum supported group size for phase adjustment: information indicating a minimum value of a group size for phase adjustment that the UE 1020 can support.
Maximum phase value: information indicating a maximum phase control value that the UE 1020 can apply to a precoding matrix.
Minimum phase value: information indicating a minimum phase control value that the UE 1020 can apply to a precoding matrix.

Meanwhile, information that may be included in the above-described response message may be delivered to the BS 1010 through RRC signaling (e.g., FeaturesSetUplinkPerCC). As a specific example, the above-described information may be delivered to the BS 1010 through FeaturesSetUplinkPerCC configured as shown in Table 4 above.

In operation S1003, the BS 1010 may, based on the response message, transmit codebook configuration information to the UE 1020. In addition, the BS 1010 may transmit SRS configuration information to the UE 1020. The BS 1010 may transmit the codebook configuration information and/or the SRS configuration information to the UE 1020 through an RRC message. Here, as described above, the first codebook may define TPMI beams. For example, the first codebook may define precoding matrices for various cases such as a 2-port UE, a 4-port UE, and an 8-port UE, and indices corresponding thereto. Meanwhile, the second codebook may define various parameters to be applied to the first codebook. For example, the second codebook may define various parameters to be applied to precoding matrices according to the first codebook and indices corresponding thereto. Various parameters may include, for example, amplitude adjustment parameters and/or phase adjustment parameters.

The codebook configuration information for the second codebook may include information indicating whether the second codebook is applied, and may additionally include at least one of the following information items:
Amplitude adjustment on/off indicator: an indicator for instructing activation or inactivation of an amplitude control function for controlling amplitudes of a precoding matrix defined by the first codebook;
Phase adjustment on/off indicator: an indicator for instructing activation or inactivation of a phase control function for controlling phases of a precoding matrix defined by the first codebook;
Information regarding an initial amplitude offset: information regarding an initial offset value for amplitude adjustment when amplitudes of a precoding matrix are cyclically adjusted;
Information regarding an initial phase offset: information regarding an initial offset value for phase adjustment when phases of a precoding matrix are cyclically adjusted;
Information regarding a step size of amplitude change: information related to configuring a step size for amplitude adjustment when amplitudes of a precoding matrix are cyclically adjusted. The information may include a step size, a quantization level, a step adjustment period, and the like;
Information regarding a step size of phase change: information related to configuring a step size for phase adjustment when phases of a precoding matrix are cyclically adjusted. The information may include a step size, a quantization level, a step adjustment period, and the like;
Information regarding an applicable amplitude super set: information regarding an amplitude super set including at least one amplitude control parameter that can be applied to a precoding matrix when amplitudes of the precoding matrix are adjusted based on a table;
Information regarding an applicable phase super set: information regarding a phase super set including at least one phase control parameter that can be applied to a precoding matrix when phases of the precoding matrix are adjusted based on a table;
Port group size for amplitude adjustment: information indicating the number of UE ports included in each of units to which different amplitudes are to be applied. In other words, this refers to information regarding a group including at least one antenna port, to which the same amplitude control parameter is to be applied, among elements of a precoding matrix; and
Phase group size for phase adjustment: information indicating the number of UE ports included in each of units to which different phases are to be applied. In other words, this refers to information regarding a group including at least one antenna port, to which the same phase control parameter is to be applied, among elements of a precoding matrix.

The enhanced uplink codebook configuration information may provide amplitude/phase control functions by using an amplitude/phase table or a super set. On the other hand, the enhanced uplink codebook configuration information may provide cyclic amplitude/phase control functions by using information related to amplitude/phase step sizes.

As a specific example, the enhanced uplink codebook configuration information may be configured as shown in Table 5 below.

TABLE 5

PUSCH-Config ::= SEQUENCE
dataScramblingIdentityPUSCH 2
txConfig = codebook
enhancedULcodebookIndicator = {enabled}
enhancedULcodebook {
Amplitude adjustment {disabled}
Phase adjustment {enabled}
}
AmplitudeConfig {
Amplitude start (ρ_s) = - 2
Amplitude step (Δρ) = 0.5
Number of amplitude values (Q) = 8
Group size for amplitude adjustment = 2
}
PhaseConfig {
Phase start (φ_s)= 0
Phase step (Δφ) = π/P
Number of phase values (P) = 8
Group size for phase adjustment = 2}
}
...}

Referring to Table 5, an enhancedULcodebookIndicator may be provided as an indicator for determining whether to activate an enhanced UL codebook. When enhancedULcodebookIndicator is configured to {enabled}), the UE 1020 may identify that PUSCH transmission is to be performed based on the activation of the enhanced UL codebook. On the other hand, if the enhancedULcodebookIndicator is configured to {disabled}, the UE 1020 may identify that PUSCH transmission is to be performed based on the inactivation of the enhanced UL codebook. The enhanced UL codebook configuration information may be defined in an enhancedULcodebook field, and the enhancedULcodebook field may include at least one of amplitude adjustment, phase adjustment, AmplitudeConfig, and PhaseConfig. Here, when Amplitude adjustment={enabled}, the UE 1020 may identify that PUSCH transmission is to be performed based on the activation of amplitude adjustment. On the other hand, when Amplitude adjustment={disabled}, the UE 1020 may identify that PUSCH transmission is to be performed based on the inactivation of amplitude adjustment. In addition, when Phase adjustment={enabled}, the UE 1020 may identify that PUSCH transmission is to be performed based on the activation of phase adjustment. On the other hand, when Phase adjustment={disabled}, the UE 1020 may identify that PUSCH transmission is to be performed based on the inactivation of phase adjustment. According to Table 5, even when the enhancedULcodebookIndicator is configured to {enabled}, the BS 1010 may configure the second codebook such that amplitude adjustment or phase adjustment can be selectively activated for the UE 1020.

Referring to Table 5, the AmplitudeConfig may include information required for amplitude adjustment and may include, as a specific example, at least one piece of information for determining a range of possible amplitude values and an amplitude port group size. For example, the BS 1010 may configure, for the UE 1020, the range of the possible amplitude values based on at least one of an Amplitude start (ρₛ), an Amplitude step (Δρ), and a Number of amplitude values (Q). According to Table 5, the amplitude range may be determined as in Equation 4 below.

$${ρ}_{i} = {ρ}_{s} + q \cdot Δρ , for q = 0 , 1 , … , Q - 1. \qquad [ Equation 4 ]$$

On the other hand, the AmplitudeConfig may be provided based on a table, as shown in Table 6 below.

TABLE 6

| Index | ρ |
|---|---|
| 0 | −2 |
| 1 | −1.5 |
| 2 | −1 |
| 3 | −0.5 |
| 4 | 0.5 |
| 5 | 1 |
| 6 | 1.5 |
| 7 | 2 |

Referring again to Table 5, the BS 1010 may configure, for the UE 1020, a unit of ports used for performing amplitude adjustment, based on the group size for amplitude adjustment. For example, when the group size for amplitude adjustment is 2, the UE 1020 may group two ports into one amplitude port group and may apply different amplitudes to each amplitude port group.

In addition, referring to Table 5, the PhaseConfig may include information required for phase adjustment and may include, as a specific example, at least one piece of information for determining a range of possible phase values and a phase port group size. According to Table 5, the BS 1010 may configure, for the UE 1020, the range of the possible phase values, based on at least one of a phase start (φₛ), a phase step ((Δφ), and a number of phase values (P). According to Table 5, the phase range may be determined as in Equation 5 below.

$${φ}_{i} = {φ}_{s} + p \cdot Δφ , for p = 0 , 1 , … , P - 1. \qquad [ Equation 5 ]$$

On the other hand, the PhaseConfig may be provided based on a table, as shown in Table 7 below.

TABLE 7

| Index | φ |
|---|---|
| 0 | 0 |
| 1 | 0.3927 |
| 2 | 0.7854 |
| 3 | 1.1781 |
| 4 | 1.5708 |
| 5 | 1.9635 |
| 6 | 2.3562 |
| 7 | 2.7489 |

Referring again to Table 5, the BS 1010 may configure, for the UE 1020, a unit of ports used for performing phase adjustment, based on the group size for phase adjustment. For example, when the group size for phase adjustment is 2, the UE may group two ports into one phase port group and may apply different phases to each phase port group. Specifically, when the UE is a 4-port UE and the group size for phase adjustment is 2, UE port 1 and UE port 2 may be grouped as phase port group 1, and UE port 3 and UE port 4 may be grouped as phase port group 2. In this case, phase adjustment e^{jφ}^{₁} may be applied to phase port group 1, and phase adjustment e^{jφ}^{₂} may be applied to phase port group 2.

On the other hand, although the above example describes only the case in which, when the group size for phase adjustment is 2, w1 and w2 are grouped as phase port group 1 and w3 and w4 are grouped as phase port group 2, the disclosure is not limited thereto, and various methods for configuring, for the UE, the group size for phase adjustment may be defined. For example, when the group size for phase adjustment is 2, it is also possible that odd-numbered ports w1 and w3 are grouped as phase port group 1, and even-numbered ports w2 and w4 are grouped as phase port group 2.

As a specific example, when the UE has 8 ports and the group size for phase adjustment is 2, the ports may be grouped as {1, 5}, {2, 6}, {3, 7}, and {4, 8}. Alternatively, the ports may be grouped as {1, 3}, {2, 4}, {5, 7}, and {6, 8}.

Here, the rule for performing grouping among antenna ports may be determined based on a pre-definition between the UE and the BS or may be determined based on separate signaling provided by the BS to the UE. For example, when the UE has 8 ports and the group size for phase adjustment is 2, the grouping into {1, 5}, {2, 6}, {3, 7}, and {4, 8} may be instructed by configuring the grouping mode to {comb4}. Alternatively, the grouping into {1, 3}, {2, 4}, {5, 7}, and {6, 8} may be instructed by configuring the grouping mode to {comb2}.

Based on the above examples, a beam determined by the UE 1020 performing amplitude adjustment and phase adjustment on the precoding matrix determined according to the TPMI may be expressed as in Equation 6 below.

$${w}^{′} = [ \begin{matrix}{ρ}_{1} {e}^{j {φ}_{1}} {w}_{1} \\ {ρ}_{1} {e}^{j {φ}_{1}} {w}_{2} \\ {ρ}_{2} {e}^{j {φ}_{2}} {w}_{3} \\ {ρ}_{2} {e}^{j {φ}_{2}} {w}_{4}\end{matrix} ] . \qquad [ Equation 6 ]$$

In operation S1004, the BS 1010 may receive an SRS from the UE 1020 through SRS transmission resources configured based on SRS configuration information. The SRS configuration information, like the second codebook configuration information, may be delivered to the UE 1020 through RRC signaling. The SRS configuration information may include SRS resource information. The SRS resource information may include at least one of an SRS resource set and an SRS resource. The SRS resource set may include SRS usage information, and the SRS resource may be configured as periodic, semi-persistent, or aperiodic. The UE 1020 may transmit the SRS based on the SRS resource information, and the BS 1010 may receive the SRS transmitted by the UE 1020 and estimate CSI.

In operation S1005, the BS 1010 may determine a TPMI based on the first codebook and precoding matrix control parameters based on the second codebook, using the SRS received from the UE 1020. For example, the BS 1010 may determine a TPMI and control parameters for configuring a beam direction in which the signal strength of CSI estimated based on the SRS received from the UE 1020 is maximized. Here, the TPMI may be determined as one of the TPMIs defined in the first codebook. In addition, the control parameters may be determined based on the manner defined through the second codebook.

In operation S1006, the BS 1010 may transmit, to the UE 1020, specific amplitude values and phase values to be applied to UL transmission, through DCI or MAC-CE signaling. On the other hand, the amplitude values and phase values may vary depending on channel conditions, scheduling conditions, and network states, and when the degree of variation exceeds a threshold, the BS may deliver the control parameters to the UE through DCI or MAC-CE signaling. Alternatively, the BS may deliver the amplitude values and phase values to the UE through DCI or MAC-CE signaling for each scheduled PUSCH.

As a specific example of operation S1006, the BS 1010 may deliver, to the UE 1020, information on at least one of an amplitude adjustment index and a phase adjustment index, by including the information in a DCI field. For example, the BS 1010 may deliver, through DCI or MAC-CE signaling, information on an amplitude adjustment index={2, 5} and a phase adjustment index={7, 2} to the UE 1020. Based on the amplitude adjustment index={2, 5}, the UE 1020 may apply the amplitude value corresponding to index 2 of the amplitude super set in Table 6 to amplitude port group 1, and sequentially apply the amplitude value corresponding to index 5 of the amplitude super set to amplitude port group 2. In other words, the UE 1020 may apply ρ₁=−1 to UE ports 1 and 2, and ρ₂=1 to UE ports 3 and 4. In addition, based on the phase adjustment index={7, 2}, the UE 1020 may apply the phase value corresponding to index 7 of the phase super set in Table 7, configured through RRC signaling, to phase port group 1, and sequentially apply the phase value corresponding to index 2 of the phase super set to phase port group 2. In other words, the UE 1020 may apply φ₁=2.7489 to UE ports 1 and 2, and may apply φ₂=0.7854 to UE ports 3 and 4.

As a specific example of operation S1006, the BS 1010 may deliver, to the UE 1020, a negative port group together with an amplitude adjustment index and a phase adjustment index. The negative port group may indicate whether to perform a multiplication operation by which each amplitude port group is multiplied by −1. For example, when the negative port group is configured as {2}, the UE 1020 may identify that a multiplication operation of multiplying by −1 may be performed on UE ports 3 and 4 corresponding to amplitude port group 2. Alternatively, the negative port group may indicate whether to perform a multiplication operation by which each phase port group is multiplied by −1. For example, when the negative port group is configured as {2}, the UE may identify that a multiplication operation of multiplying by −1 may be performed on UE ports 3 and 4 corresponding to phase port group 2. Meanwhile, the BS 1010 may configure, for the UE 1020 through RRC signaling, whether the negative port group is to be applied to the amplitude port group or to the phase port group.

In operation S1007, the UE 1020 may transmit uplink data to the BS 1010, based on the received TPMI and the received information regarding the precoding matrix control parameters. For example, the UE 1020 may determine a precoding matrix based on the received TPMI, and may determine a beam direction by adjusting the precoding matrix based on the received information regarding the precoding matrix control parameters. The UE 1020 may transmit uplink data to the BS 1010, based on the determined beam direction. Specifically, the UE 1020 may transmit a PUSCH to the BS 1010, based on the determined beam direction.

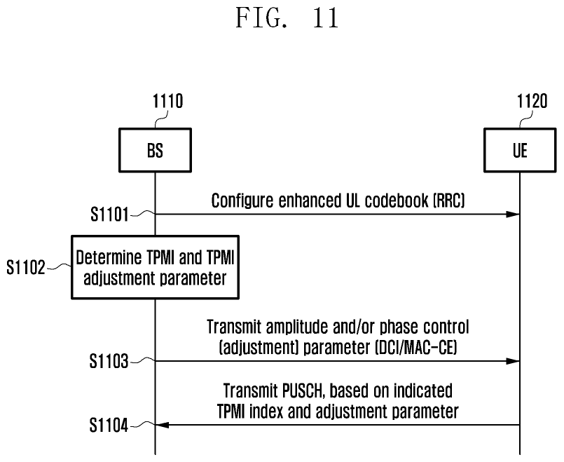

FIG. 11 illustrates a flowchart of an uplink MIMO transmission and reception method according to an embodiment of the disclosure. More specifically, FIG. 11 illustrates an example of specific interactions between a BS 1110 and a UE 1120 for updating codebook configuration information according to the uplink MIMO transmission and reception method of an embodiment of the disclosure.

In operation S1101, the BS 1110 may update, by means of a control signal, part of information related to amplitude or phase adjustment that has been previously configured for the UE 1120. For example, in a situation in which fine tuning of a TPMI beam may be relaxed, such as when the number of UEs 1120 in the network is small or when uplink MU-MIMO performance is satisfactory, the BS 1110 may decrease the super set size of amplitude values or phase values. Alternatively, the BS 1110 may inactivate amplitude adjustment or phase adjustment. The reduction of the super set size and the adjustment inactivation may be applied independently to amplitude adjustment and phase adjustment, respectively. By decreasing the super set size of a specific adjustment or by inactivating a specific adjustment, the complexity of the BS 1110 required to find an adjustment coefficient may be reduced, and signaling overhead for informing the UE 1120 of amplitude adjustment or phase adjustment information may also be reduced. On the other hand, in a situation in which fine tuning of a TPMI beam may be enhanced, such as when the number of UEs 1120 in the network is large or when uplink MU-MIMO performance is degraded, the BS 1110 may increase the super set size of amplitude values or phase values or may activate a specific adjustment that has been inactivated. The reduction in the super set size and the inactivation of adjustment may be applied independently to amplitude adjustment and phase adjustment, respectively. When the super set size of a specific adjustment is increased or when a specific adjustment is activated, the complexity of the BS 1110 and signaling overhead may increase, but uplink MU-MIMO transmission performance may be improved.

In operation S1102, the BS 1110 may update a TPMI based on the first codebook and precoding matrix control parameters based on the codebook update information. Here, updating the TPMI and the control parameters may be performed in a manner similar to the method of determining the TPMI and the control parameters described in operation S403.

In operation S1103, the BS 1110 may transmit, to the UE 1120, the updated TPMI and information regarding the updated precoding matrix control parameters. The updated TPMI and the information regarding the updated precoding matrix control parameters may be transmitted to the UE 1120 through DCI or MAC-CE signaling.

In operation S1104, the UE 1120 may transmit uplink data to the BS 1110, based on the updated TPMI and the information regarding the updated precoding matrix control parameters. The UE 1120 may determine a precoding matrix, based on the updated TPMI, and may determine a beam direction by adjusting the precoding matrix based on the information regarding the updated precoding matrix control parameters. The UE 1120 may transmit uplink data to the BS 1110, based on the determined beam direction. Specifically, the UE 1120 may transmit a PUSCH to the BS 1110, based on the determined beam direction.

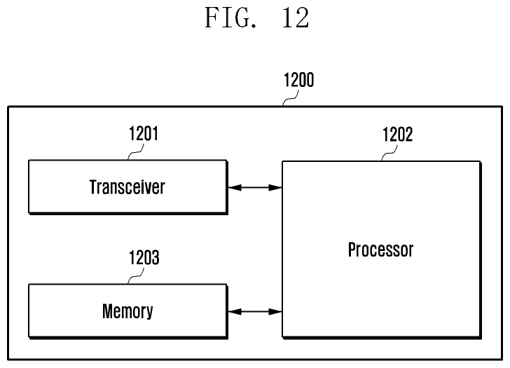

FIG. 12 illustrates a terminal or user equipment (UE) 1200 according to an embodiment of the disclosure.

The terminal is an electronic device capable of wireless communication and having various form factors, examples of the terminal may include a UE, a mobile station (MS), a cellular phone, a smartphone, a computer, a tablet, a wearable device, an Internet of Things (IoT) device, or any other device/system capable of performing wireless communication with a base station (BS) and/or another terminal through a wireless channel.

Referring to FIG. 12, the UE 1200 may include at least one transceiver (hereinafter, referred to as simply “transceiver”) 1201, at least one processor (hereinafter, referred to as simply “processor”) 1202, and at least one memory (hereinafter, referred to as simply “memory”) 1203. According to at least one or a combination of methods corresponding to the embodiments described in the present disclosure, the transceiver 1201, the processor 1202, and the memory 1203 of the UE 1200 may operate. However, components of the UE 1200 are not limited to the example components illustrated in FIG. 12. In another embodiment, the UE 1200 may further include additional components in addition to the above-mentioned components, or some components may be omitted. Further, in some embodiments, any combination of the transceiver 1201, the processor 1202, or the memory 1203 may be integrated in the form of one component.

The transceiver 1201 may be a communication circuit or communication circuitry that enables the UE 1200 to perform wireless communication with a node or an entity of a network. For example, the transceiver 1201 may enable the UE 1200 to transmit or receive a signal to or from a BS through cellular communication, or to transmit or receive a signal to or from another UE through cellular communication. For example, the transceiver 1201 may support at least one of various cellular communication technologies including 3rd generation (3G), 4th generation (4G), long term evolution (LTE), 5th generation (5G) NR, 6th generation (6G), and various cellular wireless communication technologies supported by the transceiver (1201) may include all subsequent generations of evolved wireless communications.

According to an embodiment, the UE 1200 may include a plurality of transceivers. For example, in the case of supporting evolved-universal terrestrial radio access-new radio (E-UTRA-NR) dual connectivity (EN-DC), the UE 1200 may include a first transceiver supporting the 4G LTE wireless communication and a second transceiver supporting the 5G NR wireless communication. According to another embodiment, in the case of supporting NR-dual connectivity (NR-DC), the UE 1200 may include a plurality of transceivers supporting the 5G NR wireless communication. According to still another embodiment, in the case of supporting near field wireless communication, the UE 1200 may separately include a transceiver supporting at least one standard in the group of wireless communication protocol standards as defined in the protocol standards for Bluetooth®, wireless local area network (WLAN) network (including institute of electrical and electronics engineers (IEEE) 802.11-2016 standard or its amendments, e.g., 802.11ah, 802.11ad, 802.11ay, 802.11ax, 802.11az, 802.11ba, and 802.11be, without being limited thereto).

According to an embodiment, the transceiver 1201 may include various circuit structures used to transmit or receive signals to or from a BS through a wireless channel. The signals may include control information and data. For example, the transceiver 1201 may include a radio frequency (RF) transmitter for up-converting and amplifying the frequency of a transmitted signal and an RF receiver for low-noise-amplifying a received signal and down-converting the frequency thereof. The transceiver 1201 may output a signal received through a wireless channel to the processor 1202 and may transmit, through a wireless channel, a signal output from the processor 1202.

The processor 1202 may control general operations of the UE 1200 according to embodiments of the disclosure. The processor 1202 may be implemented by one or more integrated circuit (or circuitry) (IC) chips and may execute various data processing operations. The processor 1202 may include at least one electric circuit, and may execute instructions (or a program, codes, data, etc.) stored in the memory 1203, individually, collectively or in any combination thereof. Further, the processor 1202 may include a single-core processor or multi-core processor, and may include a processor assembly including a plurality of processing circuits (circuitry) according to a specific implementation scheme.

The processor 1202 may be electrically, operatively, and/or communicatively coupled to the transceiver 1201 to control the transceiver 1201.

The processor 1202 may include at least one processor (or processing circuitry), and the at least one processor may perform the following operations individually, collectively or in any combination thereof. For example, the processor 1202 may include a communication processor (CP) configured to control communication operations and an application processor (AP) configured to control execution of an upper layer (for example, an application layer). In a specific embodiment, at least a part of the processor 1202 may be included in one chip (or IC) and the other part of the processor 1202 may be included in another chip (or IC). Otherwise, at least one processor may be included in another component, for example, the transceiver 1201 or the memory 1203.

The processor 1202 may perform or control or cause an operation of the UE 1200 for executing at least one or a combination of methods according to embodiments of the disclosure. For example, the processor 1202 may control operations of the UE 1200 for processing a downlink signal received from a BS or generating and transmitting an uplink signal to a BS. To this end, the processor 1202 may execute a computer program, codes, or instructions stored in the memory 1203, so as to control other components of the UE 1200 to enable execution of various operations.

The memory 1203 corresponds to a hardware storage device capable of temporarily or permanently storing information and may include one or more storage media. For example, the memory 1203 may include a memory assembly including one or more storage media. For example, the one or more storage media may include permanent memory, such as a hard drive, flash memory, or read-only memory (ROM), semipermanent memory, such as random access memory (RAM), cache memory, or a combination thereof.

The memory 1203 may be electrically, operatively, and/or communicatively coupled to the processor 1202 and may be accessed by the processor 1202.

The memory 1203 may store a computer program, codes, or instructions executable by the processor 1202. According to an embodiment, a computer program, codes, or instructions executable by the processor 1202 may be either stored in a single memory device or separated and distributedly stored in two or more memory devices. By executing the instructions stored in the memory 1203, the processor 1202 may perform various functions according to an embodiment of the disclosure.

According to an embodiment of the disclosure, operations of the UE 1200 may be caused to be performed based on execution of instructions (or a computer program or codes) stored in the memory 1203 by at least one processor (or processing circuitry) configured to execute the same individually, collectively, or in any combination thereof, based on processing circuitry that is not configured to execute instructions, and/or based on components of processing circuitry that is not configured to execute instructions.

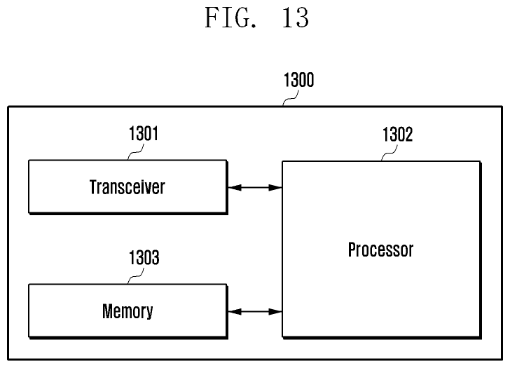

FIG. 13 illustrates a base station (BS) 1300 according to an embodiment of the disclosure.

The BS 1300 may perform wireless communication with at least one user equipment (UE) located within the area of the BS 1300 through a wireless channel. The BS 1300 may perform communication with a node or an entity of a network through wired or wireless communication.

Referring to FIG. 13, the BS 1300 may include at least one transceiver (hereinafter, referred to as simply “transceiver”) 1301, at least one processor (hereinafter, referred to as simply “processor”) 1302, and at least one memory (hereinafter, referred to as simply “memory”) 1303. According to at least one or a combination of methods corresponding to the embodiments described in the present disclosure, the transceiver 1301, the processor 1302, and the memory 1303 of the BS 1300 may operate. However, components of the BS 1300 are not limited to the example components illustrated in FIG. 13. In another embodiment, the BS 1300 may further include additional components in addition to the above-mentioned components, or some components may be omitted. Further, in some embodiments, any combination of the transceiver 1301, the processor 1302, or the memory 1303 may be integrated in the form of one component.

The transceiver 1301 may be a communication circuit or communication circuitry that enables the BS 1300 to perform wireless communication with a node or an entity of a network. For example, the transceiver 1301 may enable the BS 1300 to transmit or receive a signal to or from the UE X00 through cellular communication, or to transmit or receive a signal to or from another network entity through wireless communication. For example, the transceiver 1301 may support various cellular communication technologies including 3rd generation (3G), 4th generation (4G), long term evolution (LTE), 5th generation (5G) NR, 6th generation (6G), and various cellular wireless communication technologies supported by the transceiver (1301) may include all subsequent generations of evolved wireless communications. According to an embodiment, the transceiver 1301 may include various circuit structures used to transmit or receive signals to or from a UE through a wireless channel. The signals may include control information and data. For example, the transceiver 1301 may include a radio frequency (RF) transmitter for up-converting and amplifying the frequency of a transmitted signal and an RF receiver for low-noise-amplifying a received signal and down-converting the frequency thereof. The transceiver 1301 may output a signal received through a wireless channel to the processor 1302 and may transmit, through a wireless channel, a signal output from the processor 1302.

Meanwhile, according to an embodiment of the present disclosure, the BS 1300 may perform communication with a node or an entity of a network through wired or wireless communication. For example, the BS 1300 may perform wired or wireless communication with an adjacent BS, or a node or an entity of a core network through a backhaul network. Although not illustrated in FIG. 13, when the BS 1300 performs wired communication, the BS 1300 may further include a separate network interface for wired communication in addition to the transceiver 1301. The network interface may be referred to as network interface circuitry or communication interface circuitry.

The processor 1302 may control general operations of the BS 1300 according to embodiments of the disclosure. The processor 1302 may be implemented by one or more integrated circuit (or circuitry) (IC) chips and may execute various data processing operations. The processor 1302 may include at least one electric circuit, and may execute instructions (or a program, codes, data, etc.) stored in the memory 1303, individually, collectively or in any combination thereof. Further, the processor 1302 may include a single-core processor or multi-core processor, and may include a processor assembly including a plurality of processing circuits (circuitry) according to a specific implementation scheme.

The processor 1302 may be electrically, operatively, and/or communicatively coupled to the transceiver 1301 to control the transceiver 1301.

The processor 1302 may include at least one processor (or processing circuitry), and the at least one processor may perform the following operations individually, collectively or in any combination thereof. In a specific embodiment, at least a part of the processor 1302 may be included in one chip (or IC) and the other part of the processor 1302 may be included in another chip (or IC). Otherwise, at least one processor may be included in another component, for example, the transceiver 1301 or the memory 1303.

The processor 1302 may perform or control or cause an operation of the BS 1300 for executing at least one or a combination of methods according to embodiments of the disclosure. For example, the processor 1302 may control operations of the BS 1300 for generating and transmitting a downlink signal to a UE or processing an uplink signal received from a UE. Otherwise, the BS 1300 may transmit or receive a signal to or from a neighboring BS, transfer a signal received from a UE to an upper node of the network, or transmit a signal transferred from an upper node of the network to a UE. To this end, the processor 1302 may execute a computer program, codes, or instructions stored in the memory 1303, so as to control other components of the BS 1300 to enable execution of various operations.

The memory 1303 corresponds to a hardware storage device capable of temporarily or permanently storing information and may include one or more storage media. For example, the memory 1303 may include a memory assembly including one or more storage media. For example, the one or more storage media may include permanent memory, such as a hard drive, flash memory, or read-only memory (ROM), semipermanent memory, such as random access memory (RAM), cache memory, or a combination thereof.

The memory 1303 may be electrically, operatively, and/or communicatively coupled to the processor 1302 and may be accessed by the processor 1302.

The memory 1303 may store a computer program, codes, or instructions executable by the processor 1302. According to an embodiment, a computer program, codes, or instructions executable by the processor 1302 may be either stored in a single memory device or separated and distributedly stored in two or more memory devices. By executing the instructions stored in the memory 1303, the processor 1302 may perform various functions according to an embodiment of the disclosure.

According to an embodiment of the disclosure, operations of the BS 1300 may be caused to be performed based on execution of instructions (or a computer program or codes) stored in the memory 1303 by at least one processor (or processing circuitry) configured to execute the same individually, collectively, or in any combination thereof, based on processing circuitry that is not configured to execute instructions, and/or based on components of processing circuitry that is not configured to execute instructions.

The UE or the base station may perform various communication procedures related to the control plane or the user plane by cooperating with one or more network entities based on wireless communication. For example, the UE may communicate with a network entity (for example, an access and mobility management function (AMF), a session management function (SMF), etc.) via the base station, or the base station may perform at least one communication procedure by directly transmitting and receiving signals to/from, or relaying signals between, the network entities.

The structure of the above-described network entity will be described in more detail with reference to the drawings.

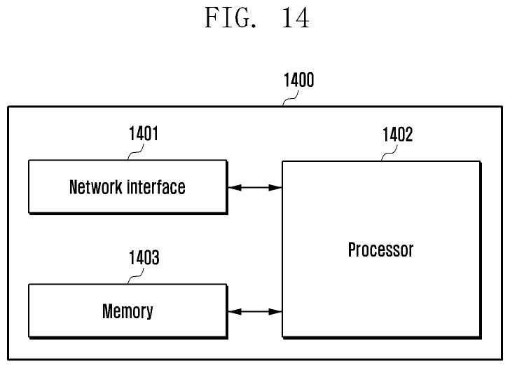

FIG. 14 illustrates a network entity 1400 according to an embodiment of the disclosure.

The network entity 1400 may include an entity (apparatus, device, or server, etc.) that performs one or more network functions (NFs) or a part of a network function constituting a core network (e.g., a 5th generation (5G) core (5GC)) in a communication system. In this case, multiple NFs may be implemented within a single network entity, or a single NF may be distributed and implemented across a plurality of network entities. In addition, when an NF is implemented within the network entity, the NF may be implemented in the form of software, and in such a case, a program for operating the NF may be stored in memory of the network entity 1400.

A single NF may be implemented by one or more instances, which may be deployed on the same network entity or distributed across multiple network entities to operate. The instance may be a software unit that logically executes a specific network function, and may be implemented in a form that is decoupled from physical hardware resources. Further, one or more NFs may be implemented in the form of one network slice to operate to satisfy specifications required by a particular service.

The NF may include at least one of an access and mobility management function (AMF), a session management function (SMF), a local session management function (L-SMF), a user plane function (UPF), a local user plane function (L-UPF), a policy control function (PCF), a unified data management (UDM), a unified data repository (UDR), a network exposure function (NEF), a network repository function (NRF), an application function (AF), a network slice selection function (NSSF), a network data analytics function (NWDAF), a network slice admission control function (NSACF), an authentication server function (AUSF), or a data network (DN), etc.

Referring to FIG. 14, the network entity 1400 may include at least one network interface 1401, at least one processor 1402 (hereinafter, “processor”), and at least one memory 1403 (hereinafter, “memory”). As described above, a NF may be implemented in the form of a physical device such as the network entity 1400, or may be virtualized and executed in the form of an instance. When implemented as an instance, the NF may not necessarily include physical components as illustrated in FIG. 14. In such a case, the instance may be logically represented as comprising one or more logical functional elements.

According to at least one or a combination of methods corresponding to the embodiments described in the present disclosure, the network interface 1401, the processor 1402, and the memory 1403 of the network entity 1400 may operate. However, components of the network entity 1400 are not limited to the example components illustrated in FIG. 14. In another embodiment, the network entity 1400 may further include additional components in addition to the above-mentioned components, or some components may be omitted. Further, in an embodiment, the network interface 1401, the processor 1402, or the memory 1403 may be integrated in the form of one component.

The network interface 1401 is a collective term for a transmitter part of the network entity 1400 and a receiver part of the network entity 1400, and may be a communication circuit for transmitting or receiving a signal to or from a user equipment (UE), a base station (BS), or another network entity. Here, the communication circuit may include both a communication circuit for wireless communication and a communication circuit for a wired communication. For example, the network interface 1401 may include a circuit, logic, hardware, etc., configured to exchange a control plane message or a user plane message with a UE, a BS, or other core network entities through wireless communication or wired communication. The network interface 1401 may operate using various protocols (e.g., non-access stratum (NAS) protocol). The network interface 1401 may also be referred to, for convenience of description or depending on implementation, as communication circuitry, network interface circuitry, or a communication interface circuitry.

The processor 1402 may control general operations of the network entity 1400 according to embodiments of the disclosure. The processor 1402 may be implemented by one or more integrated circuit (or circuitry) (IC) chips and may execute various data processing operations. The processor 1402 may include at least one electric circuit, and may execute instructions (or a program, codes, data, etc.) stored in the memory 1403, individually, collectively or in any combination thereof. Further, the processor 1402 may include a single-core processor or multi-core processor, and may include a processor assembly including a plurality of processing circuits (circuitry) according to a specific implementation scheme. Further, it should be noted that, according to another embodiment, in a case where NF is implemented in the form of an instance, the network function may be not necessarily configured by physical hardware.

According to an embodiment, the processor 1402 may be electrically, operatively, and/or communicatively coupled to the network interface 1401 to control the network interface 1401.

The processor 1402 may include at least one processor (or processing circuitry), and the at least one processor may perform the following operations individually, collectively or in any combination thereof. In a specific embodiment, at least a part of the processor 1402 may be included in one chip (or IC) and the other part of the processor 1402 may be included in another chip (or IC). Otherwise, at least one processor may be included in another component, for example, the network interface 1401 or the memory 1403.

The processor 1402 may perform or control or cause an operation of the network entity 1400 for executing at least one or a combination of methods according to embodiments of the disclosure. For example, the processor 1402 may control operations of the network entity 1400 for exchanging a control plane message or a user plane message with a UE, a BS, or other core network entities through wireless or wired communication, using various protocols (e.g., NAS protocol). To this end, the processor 1402 may execute a computer program, codes, or instructions stored in the memory 1403, so as to control other components of the network entity 1400 to enable execution of various operations.

The memory 1403 corresponds to a hardware storage device capable of temporarily or permanently storing information and may include one or more storage media. For example, the memory 1403 may include a memory assembly including one or more storage media. For example, the one or more storage media may include permanent memory, such as a hard drive, flash memory, or read-only memory (ROM), semipermanent memory, such as random access memory (RAM), cache memory, or a combination thereof.

The memory 1403 may be electrically, operatively, and/or communicatively coupled to the processor 1402 and may be accessed by the processor 1402.

The memory 1403 may store a computer program, codes, or instructions executable by the processor 1402. According to an embodiment, a computer program, codes, or instructions executable by the processor 1402 may be either stored in a single memory device or separated and distributedly stored in two or more memory devices. By executing the instructions stored in the memory 1403, the processor 1402 may perform various functions according to an embodiment of the disclosure.

According to an embodiment of the disclosure, operations of the network entity 1400 may be caused to be performed based on execution of instructions (or a computer program or codes) stored in the memory 1403 by at least one processor (or processing circuitry) configured to execute the same individually, collectively, or in any combination thereof, based on processing circuitry that is not configured to execute instructions, and/or based on components of processing circuitry that is not configured to execute instructions.

Meanwhile, although specific embodiments of the present disclosure have been described in detail, various modifications may be made without departing from the scope of the present disclosure. Therefore, the scope of the present disclosure should not be limited to the described embodiments, but should be defined by the claims and equivalents thereof.

What is claimed is:

1. A method performed by a base station in a wireless communication system, the method comprising:
transmitting, to a terminal, codebook configuration information associated with a second codebook applicable to a precoding matrix based on a first codebook, and sounding reference signal (SRS) configuration information for configuring an SRS transmission resource;
receiving, from the terminal, an SRS on the SRS transmission resource configured based on the SRS configuration information;
based on the received SRS, determining a transmitted precoding matrix indicator (TPMI) based on the first codebook and a precoding matrix control parameter based on the second codebook; and
transmitting, to the terminal, information associated with the precoding matrix control parameter and the TPMI.

2. The method of claim 1, wherein the codebook configuration information comprises at least one of information indicating whether the second codebook is applied, amplitude control information for controlling an amplitude of a precoding matrix determined based on the first codebook, or phase control information for controlling a phase of the precoding matrix.

3. The method of claim 2, wherein the amplitude control information comprises at least one of information indicating whether an amplitude control function is activated, information associated with an amplitude superset including at least one amplitude control parameter applicable to the precoding matrix, or information associated with a group including at least one antenna port to which an identical amplitude control parameter is to be applied among elements of the precoding matrix.

4. The method of claim 2, wherein the phase control information comprises at least one of information indicating whether a phase control function is activated, information associated with a phase superset including at least one phase control parameter applicable to the precoding matrix, or information associated with a group including at least one antenna port to which an identical phase control parameter is to be applied among elements of the precoding matrix.

5. The method of claim 1, further comprising:
transmitting, to the terminal, codebook update information for updating the information associated with the precoding matrix control parameter;
transmitting, to the terminal, at least one of an updated TPMI or an updated precoding matrix control parameter, based on the codebook update information; and
receiving, from the terminal, uplink data transmitted based on the at least one of the updated TPMI or the updated precoding matrix control parameter,
wherein the codebook update information includes at least one of an amplitude control parameter, a phase control parameter, information for enabling or disabling an amplitude control function, or information for enabling or disabling a phase control function.

6. A method performed by a terminal in a wireless communication system, the method comprising:
receiving, from a base station, codebook configuration information associated with a second codebook applicable to a precoding matrix based on a first codebook, and sounding reference signal (SRS) configuration information for configuring an SRS transmission resource;
transmitting, to the base station, an SRS on the SRS transmission resource configured based on the SRS configuration information;
receiving, from the base station, information associated with a transmitted precoding matrix indicator (TPMI) based on the first codebook and information associated with a precoding matrix control parameter based on the second codebook; and
transmitting uplink data to the base station, based on the information associated with the precoding matrix control parameter and the information associated with the TPMI.

7. The method of claim 6, wherein the codebook configuration information comprises at least one of information indicating whether the second codebook is applied, amplitude control information for controlling an amplitude of a precoding matrix determined based on the first codebook, or phase control information for controlling a phase of the precoding matrix,
wherein the amplitude control information comprises at least one of information indicating whether an amplitude control function is activated, information associated with an amplitude superset including at least one amplitude control parameter applicable to the precoding matrix, or information associated with a group including at least one antenna port to which an identical amplitude control parameter is to be applied among elements of the precoding matrix, and
wherein the phase control information comprises at least one of information indicating whether a phase control function is activated, information associated with a phase superset including at least one phase control parameter applicable to the precoding matrix, or information associated with a group including at least one antenna port to which an identical phase control parameter is to be applied among elements of the precoding matrix.

8. The method of claim 6, further comprising:
receiving, from the base station, codebook update information for updating the information associated with the precoding matrix control parameter;
receiving, from the base station, at least one of an updated TPMI or an updated precoding matrix control parameter, based on the codebook update information; and
transmitting uplink data to the base station, based on the at least one of the updated TPMI or the updated precoding matrix control parameter,
wherein the codebook update information includes at least one of an amplitude control parameter, a phase control parameter, information for enabling or disabling an amplitude control function, or information for enabling or disabling a phase control function.

9. A base station in a wireless communication system, the base station comprising:
at least one transceiver;
at least one processor communicatively coupled to the at least one transceiver; and
memory, communicatively coupled to the at least one processor, storing instructions executable by the at least one processor individually or in any combination to cause the base station to:
transmit, to a terminal, codebook configuration information associated with a second codebook applicable to a precoding matrix based on a first codebook, and sounding reference signal (SRS) configuration information for configuring an SRS transmission resource;
receive, from the terminal, an SRS on the SRS transmission resource configured based on the SRS configuration information;
based on the received SRS, determine a transmitted precoding matrix indicator (TPMI) based on the first codebook and a precoding matrix control parameter based on the second codebook; and
transmit, to the terminal, information associated with the precoding matrix control parameter and the TPMI.

10. The base station of claim 9, wherein the codebook configuration information comprises at least one of information indicating whether the second codebook is applied, amplitude control information for controlling an amplitude of a precoding matrix determined based on the first codebook, or phase control information for controlling a phase of the precoding matrix.

11. The base station of claim 10, wherein the amplitude control information comprises at least one of information indicating whether an amplitude control function is activated, information associated with an amplitude superset including at least one amplitude control parameter applicable to the precoding matrix, or information associated with a group including at least one antenna port to which an identical amplitude control parameter is to be applied among elements of the precoding matrix.

12. The base station of claim 10, wherein the phase control information comprises at least one of information indicating whether a phase control function is activated, information associated with a phase superset including at least one phase control parameter applicable to the precoding matrix, or information associated with a group including at least one antenna port to which an identical phase control parameter is to be applied among elements of the precoding matrix.

13. The base station of claim 9, wherein the instructions further cause the base station to:
transmit, to the terminal, codebook update information for updating the information associated with the precoding matrix control parameter;
transmit, to the terminal, at least one of an updated TPMI or an updated precoding matrix control parameter, based on the codebook update information; and
receive, from the terminal, uplink data transmitted based on the at least one of the updated TPMI or the updated precoding matrix control parameter,
wherein the codebook update information includes at least one of an amplitude control parameter, a phase control parameter, information for enabling or disabling an amplitude control function, or information for enabling or disabling a phase control function.

14. A terminal in a wireless communication system, the terminal comprising:
at least one transceiver;
at least one processor communicatively coupled to the at least one transceiver; and
memory, communicatively coupled to the at least one processor, storing instructions executable by the at least one processor individually or in any combination to cause the terminal to:
receive, from a base station, codebook configuration information associated with a second codebook applicable to a precoding matrix based on a first codebook, and sounding reference signal (SRS) configuration information for configuring an SRS transmission resource;
transmit, to the base station, an SRS on the SRS transmission resource configured based on the SRS configuration information;
receive, from the base station, information associated with a transmitted precoding matrix indicator (TPMI) based on the first codebook and information associated with a precoding matrix control parameter based on the second codebook; and
transmit uplink data to the base station, based on the information associated with the precoding matrix control parameter and the information associated with the TPMI.

15. The terminal of claim 14, wherein the codebook configuration information comprises at least one of information indicating whether the second codebook is applied, amplitude control information for controlling an amplitude of a precoding matrix determined based on the first codebook, or phase control information for controlling a phase of the precoding matrix.
